(19) United States
(12) Patent Application Publication
(10) Pub. No.: US 2025/0371782 A1
(43) Pub. Date: Dec. 4, 2025

(54) METHOD AND SYSTEM FOR MOTION GENERATION FROM INPUT TEXT

(71) Applicant: NAVER CORPORATION, Seongnam-si (KR)

(72) Inventors: Taeryung LEE, Seoul (KR); Fabien BARADEL, Meylan (FR); Thomas LUCAS, Grenoble (FR); Grégory ROGEZ, Gières (FR)

(21) Appl. No.: 19/176,560

(22) Filed: Apr. 11, 2025

Related U.S. Application Data
(60) Provisional application No. 63/655,152, filed on Jun. 3, 2024.

(51) Int. Cl. G06T 13/40; G06F 40/40; G06T 15/00

(52) U.S. Cl. CPC G06T 13/40; G06T 15/00; G06F 40/40

(57) ABSTRACT

A method for training a model for generating a representation of long-term motion from a text input comprises: training a motion encoder of an autoencoder to compress and map an input motion into a latent representation comprising a sequence of latent vectors in a discrete latent space, each latent vector representing a fixed length of motion; training a quantization module to quantize the latent vectors to a sequence of quantized latent vectors in quantized latent space; and training a motion decoder to reconstruct the quantized sequence as a sequence of single-frame pose representations. A text encoder is trained to predict a latent sequence conditioned on a text input and a duration using the mapped latent representation as a target.

### PRIORITY CLAIM

This application claims the benefit of and priority to U.S. Provisional Patent Application No. 63/655,152, filed Jun. 3, 2024, which application is incorporated by reference in its entirety herein.

### FIELD

The present disclosure relates generally to machine learning, and more particularly to methods and systems for motion generation from input text (i.e., a text input).

### BACKGROUND

For various applications, it is useful to provide long-term 3D motion generation of an entity, such as a human or a robot. 3D motion generation can be provided, for instance, via generated representations such as image frames, a sequence of parameters for generating a sequence of 3D meshes, etc.

One example application is computer vision, e.g., as disclosed in Cai et al., Deep video generation, prediction and completion of human action sequences, In ECCV, 2018; Kim et al., How transferable are video representations based on synthetic data?, NeurIPS, 2022; and Varol et al., Synthetic humans for action recognition from unseen viewpoints, IJCV, 2021. Another application is robotics, e.g., as disclosed in Gao and Huang, Evaluation of socially-aware robot navigation, Frontiers in Robotics and Al, 2022; Liu et al., Robot navigation in crowded environments using deep reinforcement learning, In IROS, 2020; Salzmann et al., Robots that can see: Leveraging human pose for trajectory prediction, IEEE RAL, 2023; and Sisbot et al., A human aware mobile robot motion planner, IEEE Transactions on Robotics, 2007.

Human motion synthesis is naturally formulated as a generative modeling problem. Various motion synthesis methods have relied on Generative Adversarial Networks (GANs), e.g., as disclosed in Ahn et al., Text2Action: Generative adversarial synthesis from language to action, In International Conference on Robotics and Automation (ICRA), 2018; Lin and Amer, Human motion modeling using DVGANs, arXiv preprint, arXiv:1804.10652, 2018; Variational Auto-encoders (VAEs), e.g., as disclosed in Guo et al., Action2motion: Conditioned generation of 3D human motions, In ACM MM, 2020; Petrovich et al., Action-conditioned 3D human motion synthesis with transformer VAE, In ICCV, 2021; Normalizing flows, e.g., as disclosed in Henter et al., MoGlow: Probabilistic and controllable motion synthesis using normalising flows, TOG, 2020; Zanfir et al., Weakly supervised 3D human pose and shape reconstruction with normalizing flows, In ECCV, 2020, diffusion models, e.g., as disclosed in Shafir et al., Human motion diffusion as a generative prior, arXiv preprint arXiv:2303.01418, 2023; Tevet et al., Human motion diffusion model, In ICLR, 2023; Tseng et al., Edge: Editable dance generation from music, 2022; Yuan et al., Physdiff: Physics-guided human motion diffusion model, 2022, or a VQVAE framework, e.g., as disclosed in Lee et al., Multiact: Long-term 3d human motion generation from multiple action labels, In AAAI, 2023; Lucas et al., Posegpt: Quantization-based 3d human motion generation and forecasting, In ECCV, 2022; Zhang et al., T2m-gpt: Generating human motion from textual descriptions with discrete representations, In CVPR, 2023; and Zhou and Wang, Ude: A unified driving engine for human motion generation, 2022.

Motion can be predicted with or without observed frames, from the past only, or also with future targets. Other forms of conditioning can be used, such as speech, music, action labels, or text. In the presence of text inputs, human motion generation can also be cast into a machine-translation problem. A joint cross-modal latent space can also be used.

Early action conditional motion models relied on Conditional GANs, e.g., as disclosed in Cai et al., Deep video generation, prediction and completion of human action sequences. In ECCV, 2018; and conditional VAEs, e.g., as disclosed in Guo et al., Action2motion: Conditioned generation of 3D human motions, In ACM MM, 2020; Maheshwari et al., Mugl: Large scale multi person conditional action generation with locomotion, 2021; and Petrovich et al., Action-conditioned 3D human motion synthesis with transformer VAE, In ICCV, 2021. Other, more flexible variants have been disclosed using the VQVAE framework. For instance, PoseGPT, disclosed in Lucas et al., Posegpt: Quantization-based 3d human motion generation and forecasting. In ECCV, 2022, can allow conditioning on past observations relying on a GPT-like model to sample motions.

Human motion can be generated conditionally on text. Examples include the Text2Action model, disclosed in Ahn et al., Text2action: Generative adversarial synthesis from language to action, In ICRA, 2018, which is based on an RNN conditioned on a short text. MotionCLIP, as disclosed in Tevet et al., Motionclip: Exposing human motion generation to clip space, 2022, aligns text and motion by leveraging the powerful CLIP model, e.g., as disclosed in Radford et al., Learning transferable visual models from natural language supervision, In International Conference on Machine Learning (ICML), 2021, as the text encoder, which enables out-of-distribution motion generation.

TEMOS, as disclosed in Petrovich et al., TEMOS: Generating diverse human motions from textual descriptions, In ECCV, 2022, extends the VAE-based approach in ACTOR, disclosed in Petrovich et al., Action-conditioned 3D human motion synthesis with transformer VAE, In ICCV, 2021, to obtain a text-conditional model using an additional text encoder. T2M, e.g., as disclosed in Guo et al., Generating diverse and natural 3d human motions from text, In CVPR, 2022, discloses a large-scale dataset that is better suited to the task of text-conditional long motion generation. TM2T, as disclosed in Guo et al., Tm2t: Stochastic and tokenized modeling for the reciprocal generation of 3d human motions and texts, In ECCV, 2022, jointly considers text-to-motion and motion-to-text predictions and provides performance gains from jointly training both tasks. Another method, T2M-GPT, disclosed in Zhang et al., T2m-gpt: Generating human motion from textual descriptions with discrete representations, In CVPR, 2023, achieved competitive performance using the VQVAE framework, where motion is encoded into discrete indices, which are then predicted using a GPT-like model.

Diffusion-based models have also been disclosed for generating motion conditionally on text, e.g., Tevet et al., Human motion diffusion model, In ICLR, 2023. Other methods, such as MultiAct, as disclosed in Lee et al., Multiact: Long-term 3d human motion generation from multiple action labels, In AAAI, 2023; and ST2M, as disclosed in Li et al., Sequential texts driven cohesive motions synthesis with natural transitions, In ICCV, 2023; and TEACH, as disclosed in Athanasiou et al., TEACH: Temporal Action Compositions for 3D Humans, In 3DV, 2022, utilize a recurrent generation framework with a past-conditional VAE to generate multiple actions sequentially. These methods each require sequential datasets, e.g., BABEL (Punnakkal et al., BABEL: Bodies, action and behavior with English labels, In CVPR, 2021) for training, which is a significant drawback. Another method, DoubleTake, a part of PriorMDM, e.g., as disclosed in Shafir et al., Human motion diffusion as a generative prior, arXiv preprint arXiv:2303.01418, 2023, that utilizes MDM, e.g., as disclosed in Tevet et al., Human motion diffusion model, In ICLR, 2023, as a generative prior, individually generates the actions and connects them with a diffusion model.

Recent trends have focused on controlling generated human motions with input prompts such as discrete action labels, e.g., Guo et al., Action2motion: Conditioned generation of 3D human motions, In ACM MM, 2020; Lucas et al., Posegpt: Quantization-based 3d human motion generation and forecasting, In ECCV, 2022; Maheshwari et al., Mugl: Large scale multi person conditional action generation with locomotion, 2021; Petrovich et al., Action-conditioned 3D human motion synthesis with transformer VAE, In ICCV, 2021; Yang et al., Pose guided human video generation, In ECCV, 2018; or free-form text, e.g., as disclosed in Guo et al., Generating diverse and natural 3d human motions from text, In CVPR, 2022; Guo et al., Tm2t: Stochastic and tokenized modeling for the reciprocal generation of 3d human motions and texts, In ECCV, 2022; Petrovich et al., TEMOS: Generating diverse human motions from textual descriptions, In ECCV, 2022; Plappert et al., Learning a bidirectional mapping between human whole body motion and natural language using deep recurrent neural networks, Robotics and Autonomous Systems, 2018; Stoll et al, Text2sign: Towards sign language production using neural machine translation and generative adversarial networks, IJCV, 2020; Zhang et al., T2m-gpt: Generating human motion from textual descriptions with discrete representations, In CVPR, 2023, Zhang et al., Motiondiffuse: Text-driven human motion generation with diffusion model, arXiv preprint arXiv:2208.15001, 2022.

However, controllable synthesis of long-term human motion is less common and remains challenging, mainly due to the scarcity of long-term training data. Known approaches for generating long-term motion from a text input conventionally have been based on recurrent methods, using previously generated motion as input for a next step to create long-term motion. Such approaches have various drawbacks. One drawback is that such approaches rely on sequential databases for training, which are expensive. Another drawback is that such methods yield unrealistic gaps between motions generated at each step.

### SUMMARY

Provided herein, among other things, are methods and systems using one or more processors for training a model for generating a representation of long-term motion from a text input. An example method comprises training an autoencoder, which training comprises: training a motion encoder of the autoencoder to compress and map an input motion into a latent representation comprising a sequence of latent vectors in a discrete latent space, each latent vector representing a fixed length of motion; training a quantization module of the autoencoder to quantize the sequence of latent vectors to a sequence of quantized latent vectors in quantized latent space; and training a motion decoder of the autoencoder to reconstruct the quantized sequence of latent vectors as a sequence of single-frame pose representations. A text encoder connected to the autoencoder is trained to predict a latent sequence conditioned on a text input and a duration using the mapped latent representation generated by the trained motion encoder as a target. Training the autoencoder and training the text encoder both use a dataset of single actions and associated text. In the trained model, the trained text encoder receives a text input comprising a plurality of phrases, where each phrase describes an action, and processes the received text input and a received duration to predict a latent sequence, the trained quantization module quantizes the latent sequence from the predicted latent sequence, and the trained motion decoder decodes the quantized latent sequence to output parameters for generating the representation of long-term motion. The representation of long-term motion is provided for display on at least one display, and/or control of at least one autonomous device.

Other embodiments provided methods for generating a long-term motion representation, the long-term motion comprising a plurality of consecutive actions and a transition between each consecutive pair of the consecutive actions. A text input is received comprising a plurality of phrases, each phrase describing an action, wherein the plurality of phrases have a length that is independent of the length of a corresponding motion. One or more durations are received, the durations comprising a motion length for each action. The long-term motion representation is generated conditioned on the text input and the durations, wherein the generating comprises: predicting a latent representation comprising a continuous stream of latent vectors, each latent vector representing a fixed length of motion, each latent vector comprising a vector in a discrete latent space; and decoding the latent representation comprising the predicted continuous stream of latent vectors using a motion decoder to continuously reconstruct the long-term motion representation. The motion decoder is a decoder of an autoencoder trained to compress motion to sequences of latent vectors, the autoencoder comprising the motion decoder and a quantization module. The autoencoder during training further comprises a motion encoder, which may be removed or bypassed during inference. The long-term motion representation may be provided conditioned on the text input and the durations for display on at least one display, and/or control of at least one autonomous device. In some methods, the text encoder and the autoencoder may be trained with a dataset of single actions and associated text.

According to another embodiment, a processor-based system for generating a long-term motion representation is provided, the long-term motion comprising a plurality of consecutive actions and a transition between each consecutive pair of the consecutive actions. The system comprises: a text encoder configured to: receive a text input comprising a plurality of phrases, each phrase describing an action, wherein the plurality of phrases have a length that is independent of the length of a corresponding motion; receive one or more durations, the durations comprising a motion length for each action; and predict a latent representation comprising a continuous stream of latent vectors, each latent vector representing a fixed length of motion, each latent vector comprising a vector in a discrete latent space. The system further comprises a motion decoding autoencoder comprising: a quantization module configured to quantize and concatenate the continuous stream of latent vectors to provide a sequence of quantized latent vectors in quantized latent space; and a motion decoder configured to decode the sequence of quantized latent vectors to continuously reconstruct the long-term motion representation, e.g., implemented by one or more processors. A device may be provided for using the long-term motion representation for visual display on at least one display, and/or control of at least one autonomous device.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. Drawings may not be to scale. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example system architecture for long-term motion generation from a text input.

FIG. 2 shows an example training method for the system in FIG. 1.

FIG. 3 shows an example inference method for long-term motion generation.

FIGS. 4A-4B illustrates an example VQVAE model.

FIG. 5 illustrates an example text encoder.

FIG. 6 illustrates an overview of an example operation of a long-term motion generation model.

FIGS. 7A-7D illustrate experimental results using example long-term motion generation models.

FIGS. 8A-8B show a comparison of the generation performance of a single action to previous state-of-the-art methods for Single-action on BABEL and HumanML3D test sets, respectively.

FIG. 9 shows an example visual result obtained from an example long-term motion generator model, where a stream of input texts including the phrases “A person moves forward”→“A person runs forward and stops”→“Jumps forward” was used to condition the model, and the model produced a matching continuous motion from a sequence of generated poses.

FIGS. 10(a)-10(b)(h) show a sequence (letter order corresponding to forward in the sequence) of video frames from a portion of an example visualization of generated long-term motions obtained with an example method in response to the third example text input above: “Walks backward, then walk forward to original position”→“Raise both arms and squat”→“Walks forward a couple steps, then turn back, walk back to the original position.” The first action (“Walks backward, then walk forward to original position”) is shown in the frames in FIGS. 10(a)-10(aj), and a portion of the second action (“Raise both arms and squat”) are shown in the frames in FIGS. 10(ak)-10(bh).

FIG. 11 shows an example network and hardware system architecture for performing example methods.

In the drawings, reference numbers may be reused to identify similar and/or identical elements.

### DETAILED DESCRIPTION

### Introduction

Real-life human motion (or motion of another entity such as a robot or another animal) is continuous, and can be viewed as a temporal composition of actions, with transition in between. Although various methods for the text-conditional generation of short actions are known in the art, modeling smooth and realistic transitions remains a core challenge for generating long-term motions usable in practical applications.

Human motion is typically represented as a temporal sequence of 3D points, e.g., human meshes or skeletons, or a sequence of model parameters that produce such 3D representations, such as disclosed in Loper et al., SMPL: A skinned multiperson linear model, ACM TOG, 2015; and Pavlakos et al., Expressive body capture: 3D hands, face, and body from a single image, In CVPR, 2019. Plausible human motion usually represents a very small portion of these representation spaces. For instance, sequences of random samples do not produce any realistic motion.

It is thus useful to compress human motion into a discrete latent space. Example compression techniques have been shown to be beneficial for reconstruction and manipulation, e.g., as disclosed in Lucas et al., Posegpt: Quantization-based 3d human motion generation and forecasting, In ECCV, 2022; and Zhang et al., T2m-gpt: Generating human motion from textual descriptions with discrete representations, In CVPR, 2023.

Existing methods in the art for long-term motion generation exhibit significant limitations and drawbacks. For instance, existing methods such as MultiAct (Lee et al, Multiact: Long-term 3d human motion generation from multiple action labels. In AAAI, 2023), TEACH (Athanasiou et al., TEACH: Temporal Action Compositions for 3D Humans, In 3DV, 2022), or ST2M (Li et al., Sequential texts driven cohesive motions synthesis with natural transitions, In ICCV, 2023) rely on sequential data for training. Compared to single-action datasets, such as disclosed in Guo et al., Action2motion: Conditioned generation of 3D human motions, In ACM MM, 2020; Guo et al., Generating diverse and natural 3d human motions from text, In CVPR, 2022, which contain annotations for short actions, a sequential dataset, such as disclosed in Lee et al., Dancing to music, In NeurIPS, 2019; or Punnakkal et al., BABEL: Bodies, action and behavior with English labels, In CVPR, 2021, contains frame-level annotations for each individual action and transition within long-term motion.

Previous approaches for generating long-term motion have employed recurrent methods, using previously generated motion (e.g., motion chunks) as input for the next step to create long-term motion. While training with sequential datasets provides valuable data to capture how transitions connect consecutive actions, acquiring such dense frame-level annotation at scale is expensive, and determining the segment between actions is not trivial. In addition, capturing transitions for all possible pairs of actions at scale is currently impossible. Among other things, this dependency limits the applicability of existing methods to new domains.

An additional drawback of existing methods is that they empirically struggle to create smooth and realistic transitions. It is believed that this is due to discontinuities in the generation process when chaining actions together. Such discontinuous methods generate unrealistic gaps between the consecutive motions generated at each step.

For example, most prior methods, such as TEACH, MultiAct, or ST2M, recurrently generate the long-term motions at two granularities: 1) actions of each step are conditioned on the output of the previous step; and 2) those actions are concatenated into long-term motion. Another method, DoubleTake, disclosed in Shafir et al., Human motion diffusion as a generative prior, arXiv preprint arXiv:2303.01418, 2023, uses an MDM, as disclosed in Tevet et al., Human motion diffusion model, In ICLR, 2023 to generate actions independently and blends them into a long-term motion with a diffusion model. This approach also operates at two granularities, generating individual actions and merging them, resulting in abrupt speed changes and discontinuities between consecutive actions. These result in abrupt speed changes and discontinuities between the outcomes of adjacent actions.

Example systems and methods are provided for generating long-term 3D human motion, such as by generating a sequence of actions in response to a given text sequence input, including but not limited to a stream of multiple phrases, e.g., sentences, a paragraph, etc., and smoothly connecting them with transitions. Example methods and systems, implemented via one or more processors, can generate long-term motion, such as a long sequence of representations of smoothly connected actions, from a stream of arbitrary-length input text sequences.

Example methods can be implemented, e.g., in a straightforward manner to provide a continuous long-term generation system that can be trained without sequential data. Generated human motion sequences can be of any desirable length, up to infinite sequences.

A sequence of long-term 3D motion is used herein to refer to a sequence of a plurality of short-term 3D motions with transitions therebetween, where each short-term motion represents an independent action of an entity (e.g., a person doing a first action for a first given time length with a transition to a person doing a second action for a second given time length, etc.; i.e., a plurality of consecutive actions with a transition between each consecutive action). More specifically, “long-term” as used herein generally refers to a plurality of discrete steps with at least one transition between sequential pairs of discrete steps. Long-term motion generation (e.g., human motion generation) can occur over a time of, for instance, 1, 2, 3, 4, 5, 10, 20, etc., seconds or longer, or over a plurality of frames, e.g., 3, 4, 5, 10, 20, etc. or more.

Generated long-term motion can be continuous. “Continuous” refers to a beginning of motion at an arbitrary time step (tᵢ) starting from an end of motion at a most recent previous time step (tᵢ₋₁).

An example system for long-term motion generation includes a motion decoder such as can be provided by an autoencoder that is configured to compress and discretize motion. One such type of autoencoder that may be used in example methods and systems herein is embodied in a one-dimensional (1 D) convolutional vector quantization variable autoencoder (VQVAE), which can be trained to compress motion to sequences of latent vectors. Example features of VQVAEs are disclosed in Aaron van den Oord et al., Neural Discrete Representation Learning, 31^{st} Conference on Neural Information Processing Systems (NIPS 2017), Long Beach, CA, USA, arXiv:1711.00937v2, 30 May 2018.

The present inventors have recognized that a model, which can stay at a single granularity (e.g., on the fly in a single step) instead of generating individual actions and merging them, can alleviate issues such as abrupt speed changes and discontinuities between consecutive actions, and generate smoother transitions for generation of long-term motion. Accordingly, methods disclosed herein are adapted to fix the representing range of latent vectors (i.e., receptive field) to yield an effective continuous generation that can be trained without sequential data.

In contrast to previous approaches, such as Athanasiou et al., TEACH: Temporal Action Compositions for 3D Humans, In 3DV, 2022; Petrovich et al., TEMOS: Generating diverse human motions from textual descriptions, In ECCV, 2022, Shafir et al., Human motion diffusion as a generative prior, arXiv preprint arXiv:2303.01418, 2023; and Tevet et al., Human motion diffusion model, In ICLR, 2023, where a single latent vector represents the entire action available at each step, in example methods herein each latent vector can represent a fixed length of human motion (i.e., a fraction of an entire action). Among other benefits, this can enable continuous decoding of the semantics from textual descriptions without creating a duration mismatch between train and test sequences. Example methods can employ a 1D convolutional VQVAE to learn such a latent representation.

During an example training method herein, the motion decoder can be combined with a motion encoder, e.g., in the autoencoder. In an initial training phase, the motion encoder and motion decoder can be trained to encode short human motion into learned discrete (specific) tokens. In some example methods the human motion can be compressed or discretized into a “dictionary” or “codebook” (herein, codebook). In some example methods, the codebook can be split so that, for example, a single vector can be split into multiple chunks. This can help with representation. In other embodiments, a single codebook may be provided or used. Following this first training phase, the trained motion encoder and motion decoder can be frozen.

A text encoder, e.g., a transformer-based model configured to perform predictions from text, predicts latent sequences given an input text. In a subsequent training phase, the text encoder can be coupled to the trained motion encoder (e.g., of the autoencoder), and the trained motion decoder can be removed (“removing” refers to the model being removed from the overall model or system, or bypassed within the overall model or system). The text encoder then can be trained for causal prediction of latent sequences representing motion over time steps. In this subsequent training phase, the trained motion encoder can supervise the text encoder.

At inference, the motion encoder can be removed, and the trained motion decoder can be coupled to the trained text encoder, e.g., stacked. Input text and desired motion length, or duration, is received by the text encoder. The text encoder encodes the semantic information for the corresponding temporal dimension and produces a latent sequence, such as but not limited to codebook or other indices. The indices are input to the motion detector, which decodes the indices to produce represented motion (i.e., a sequence of frames representing long-term motion, or a sequence of 3D pose information or parameters for generating same in a downstream step). For example, a text sequence can be used to predict a continuous stream of latent vectors. This continuous stream is then decoded into motion by the VQVAE decoder.

Using 1 D convolutions with a local temporal receptive field avoids errors such as may be provided by temporal inconsistencies between training and generated sequences. This constraint on an example autoencoder, e.g., a VQVAE, allows the VQVAE to be trained with short sequences (e.g., alone), and produces smoother transitions between motions. Providing a 1D convolutional VQVAE allows all motion to be compressed into a very short human motion representation, which is an improvement over prior approaches such as transformer-based decoding methods.

Example methods and systems can be conditioned on, e.g., raw input text, and in response generate smooth long-term human motion, without a need for additional post-processing. By contrast, existing human motion generation methods require post-processing methods to generate more realistic transitions between pairs of human motions. However, it is also possible to generate long-term motion by further using optional context of any of various types, such as but not limited to information about the scene, observation of past motion of variable length, target poses and target action and object pairs, semantic action/object pairs, or combinations. Example systems and methods can provide a rich and highly flexible combination of contextual information.

Further, example systems and methods can generate long-term human motion with smooth transitions without training on long-term sequences. By contrast, existing methods must be trained using datasets that contain long-term human motion (sequential datasets).

Example methods and systems can be straightforward to implement, can operate on the fly at inference, can be conditioned on raw text input, and can perform without the need to have seen long sequences of human movement during training. Because long-term training data need not be used, supervised transitions between actions need not be provided. Instead, example training data is supervised by providing motion and associated text, and during training the example model can generate the long-term sequence including actions that are close in time steps.

Experiments herein demonstrate features of example methods referred to as text-to-long-term motion (T2LM). T2LM provides a continuous long-term generation framework that operates without the need for (long-term) sequential datasets. Example methods using T2LM are demonstrated to outperform prior long-term generation models while addressing the constraint of requiring sequential data. Example methods have also been shown to provide results comparable to current state-of-the-art single-action generation methods.

### Long-Term Motion Generation System

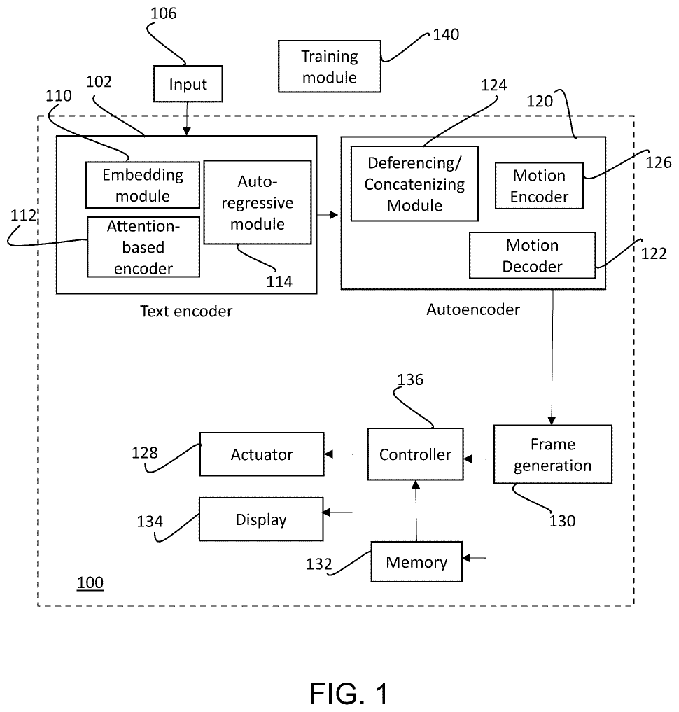

Referring now to the drawings, FIG. 1 shows an example architecture of a system 100 that may be implemented in a processor-controlled device, such as but not limited to a computer (e.g., a computer with a monitor) or an autonomous device (e.g., a robot or autonomous vehicle (e.g., a drone capable of driving, flying or submerging underwater, or a combination thereof)), for generating and displaying or using long-term motion from an input text.

The example system 100 includes a text encoder 102 and an autoencoder 104. The text encoder 102 can be transformer-based in that it includes at least one transformer layer. The text encoder 102 is configured to receive a text input, e.g., from an external input 106 such as an input/output device (keyboard, mouse, touch screen, stylus, etc.), a network connection, a wireless connection, a bus, or any other suitable input, and is trained to predict indices, e.g., codebook indices or pose indices, for the autoencoder 104. The text input includes a plurality of text groups, chunks, or phrases, such as but not limited to sentences. A plurality of phrases may be embodied in a paragraph or other text group. Each phrase can describe an action, such that the plurality of phrases describes at least two actions. The plurality of phrases have an arbitrary length, that is, they can have any suitable length, and such a length can be independent of the length of a corresponding motion.

The text encoder 102 can also receive one or more durations, as described in further detail herein. Durations may be provided, e.g., via the input 106, generated internally, e.g., from a prior, or provided in any other suitable way. A duration provides a motion length for each action, examples of which are set out herein.

The text encoder 102 is configured to predict a latent representation comprising a continuous stream of latent vectors conditioned on the text input and the duration. Each latent vector represents a fixed length of motion, and includes or is embodied in a vector in a discrete latent space. To predict latent representations, the text encoder 102 includes an embedding module 110, an attention-based encoder, e.g., a transformer-based encoder 112, and an auto-regressive module 114, examples of which are described in more detail below.

The text encoder 102 is coupled to (in communication with) an autoencoder 120. The autoencoder 120 includes a motion decoder 122, a quantization module (i.e., dereferencing/concatenation module) 124, and (at least during training) a motion encoder 126. The quantization module 124 is configured to quantize and concatenate the continuous stream of latent vectors to provide a sequence of quantized latent vectors in quantized latent space. The motion decoder 122 is configured to decode the sequence of quantized latent vectors to continuously reconstruct the long-term motion representation. During training, the motion encoder 126 is configured to compress and map an input motion into a latent representation comprising a sequence of latent vectors in the discrete latent space.

In an example system 100, the motion decoder 122 is a convolutional decoder, and the motion encoder 126 is a convolutional encoder of the autoencoder 120, which is embodied in a vector quantization variable autoencoder (VQVAE). In this way, an example motion decoder may be embodied in a 1D convolutional decoder of a VQVAE.

Generated motion may be provided, e.g., as a sequence of 3D mesh or skeleton coordinates or 3D pose parameters, to a frame generation module 130 for providing motion frames for various downstream applications. The generated long-term motion representations, e.g., parameters generated directly from the motion decoder 122, frames generated from the frame generation module 130 representing 3D poses, sequences of 3D meshes, etc., may be stored, e.g., in a non-transitory memory or working memory (e.g., RAM) 132, or displayed, e.g., output to a (internal or external) display 134, and/or output to a (internal or external) controller 136 (having memory) for controlling one or more downstream applications. The downstream applications may be performed, for instance, using the display 134 (e.g., displaying 3D avatars in a virtual environment), an actuator 138 (e.g., for providing controlled movement of an autonomous device, providing feedback, etc.), or other interface or actuation components of an autonomous device.

A training module 140 may be provided externally or internally to the system 100 for training learnable components such as the text encoder 104 and the autoencoder. The training module 130 may, but need not, perform end-to-end training. Example systems and methods herein provide a continuous long-term generation system that can be trained and operate without the need for sequential datasets.

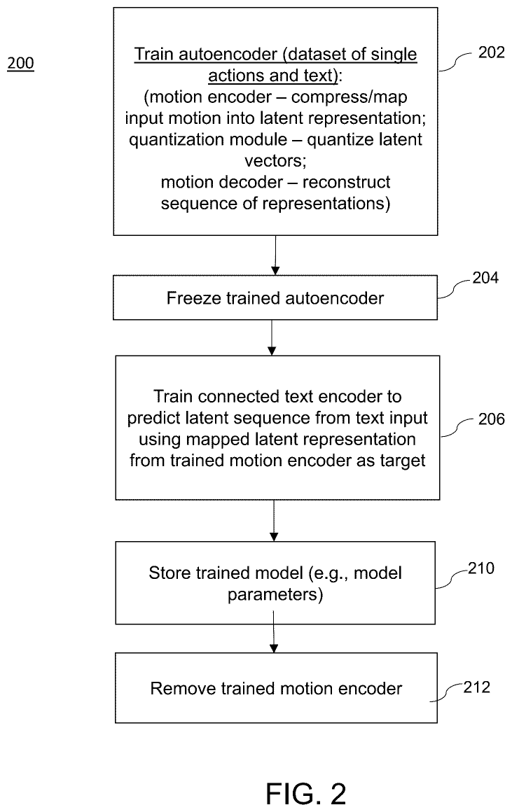

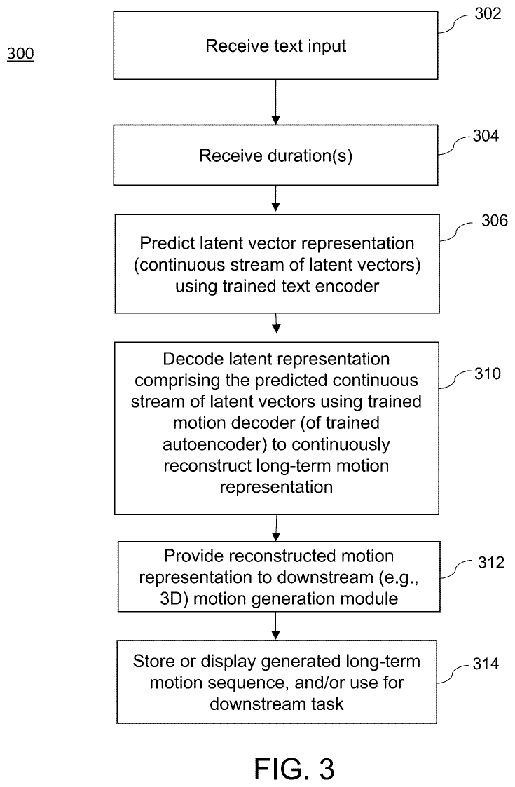

FIG. 2 shows an example training method 200 for the system 100, and FIG. 3 shows an example inference method 300. Generally, during training, an autoencoder in example models learn to compress human motion into a discrete space and reconstruct motion from it, and an autoregressive text encoder is configured and trained to map a given text to a sequence in the discrete latent space learned by the autoencoder. The combined model is thus configured and trained to generate long-term motion sequences corresponding to input text streams.

An example training method 200 first trains at 202 the autoencoder, e.g., the VQVAE 120, including training the motion encoder 126 to map an input motion into a sequence in a discrete latent space, the quantization module 124 to quantize the sequence of latent vectors to a sequence of quantized latent vectors in quantized latent space, and the motion decoder 122 to reconstruct the quantized sequence of latent vectors as a sequence of single-frame pose representations.

The mapped latent sequence is used as a target for the text encoder 102, which can be embodied in a text-and-length conditional latent prediction model. The trained autoencoder is frozen at 204, and the text encoder, connected to the autoencoder, is trained at 206 to predict a latent sequence from a text input and duration. A mapped latent representation from the trained motion encoder of the autoencoder is used as a target. The trained model, e.g., the updated model parameters, can be stored at 210. As the trained motion encoder is preferably not used in inference, it can be removed (disconnected, bypassed, etc.) from the autoencoder and/or system at 212.

Both the autoencoder and the text encoder are trained with data (e.g., one or more datasets) of single actions and accompanying texts. Unlike recurrent methods, example methods herein do not need to train a motion posterior conditioned on past motion. Instead, the autoencoder is used to learn a conditionless prior, enabling the learning of smooth motion transitions without needing sequential data. This approach, which departs from methods taking all past motion into account, provides an effective way to avoid discrepancies between short training sequences and long sequences at inference time.

In an example human motion generation operation method (inference) 300 using the trained system 100, the text encoder receives at 302 a text input comprising a plurality of phrases, where each phrase describes an action. The phrase length is arbitrary, in that the plurality of phrases have a length that is independent of the length of a corresponding motion. At 304, the text encoder 102 receives one or more durations (each comprising a motion length for each action), which may be via an input or may be generated, e.g., from a prior. The durations provide motion lengths, or a desired length for each action in the stream. At training time, durations can be extracted from the data, while at inference, durations can be either treated as an input or sampled from a prior (e.g., an average duration obtained from training data of action described by a phrase).

The text encoder 102 predicts at 306 a latent vector representation conditioned on the text input and the duration(s) that is embodied in a continuous stream of latent vectors. Each latent vector represents a fixed length of motion, and comprises a vector in a discrete latent space. In some example methods, indices, e.g., VQVAE codebook indices, are estimated (predicted) for each text input. The estimated indices may be dereferenced in a codebook or other structured index to identify latent vector representations that are concatenated to create a sequence, e.g., a continuous stream, of quantized latent vectors.

The stream of latent vectors is then passed through the motion decoder 122, e.g., in a trained 1D convolutional VQVAE decoder. The motion decoder 122 decodes the (e.g., quantized and concatenated) latent representation at 310 to continuously reconstruct the desired long-term motion representation. The 1D convolutional nature of an example VQVAE, together with an adequately constrained (e.g., local) temporal receptive field, enables the motion decoder 122 to treat this continuous input stream while computing internal features with the same temporal range as at training time. This allows the VQVAE to be trained with short sequences only and can produce smoother transitions. Example methods using the system 100 of FIG. 1 can successfully leverage a conditionless prior learned by the 1D convolution layer, enabling continuous decoding and the generation of smooth, realistic long-term motion.

The reconstructed long-term-motion representation may be provided, e.g., output, to a downstream module for any of various downstream processed. For example, a downstream 3D frame generation module may be employed at 312 to generate a sequence of frames with 3D poses, meshes, skeletons, etc. These generated sequences and/or the reconstructed long-term-motion representation directly may be stored, displayed, or used for one or more additional downstream tasks at 314.

### Example VQVAE Model

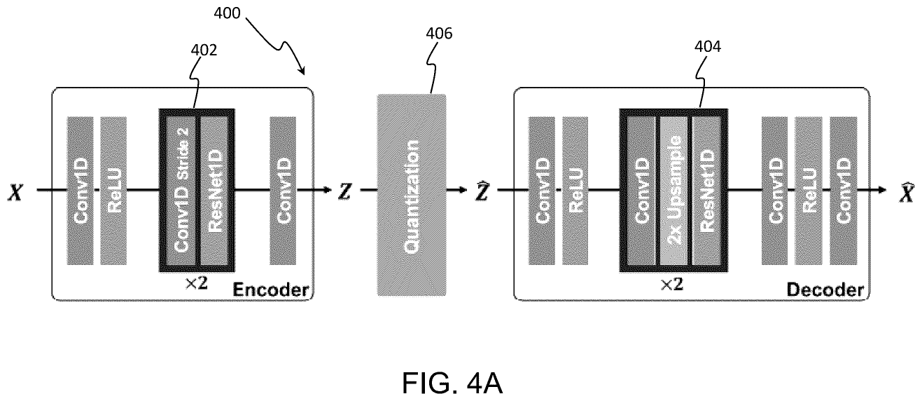

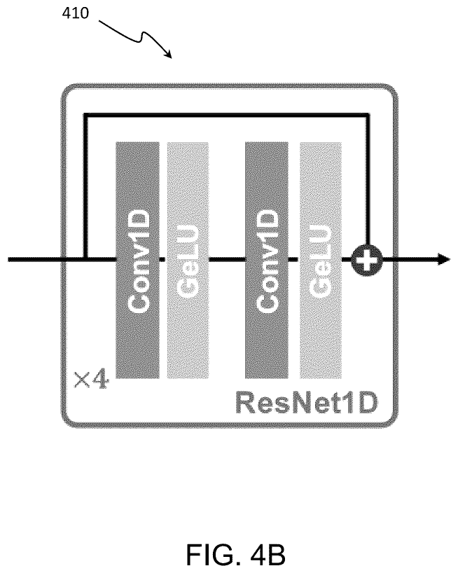

As illustrated in FIG. 4A, a motion decoding VQVAE 400 in an example system includes a motion encoder E_{conv} 402, a motion decoder D_{conv} 404, and a quantization module Q 406 using a codebook V. The example VQVAE 400 may include one or more features or layers such as but not limited to those disclosed in U.S. patent application Ser. No. 17/956,022, filed Sep. 29, 2022, entitled MOTION GENERATION SYSTEMS AND METHODS, as well as those disclosed in Lucas et al., Posegpt: Quantization-based 3d human motion generation and forecasting, In ECCV, 2022; Siyao et al., Bailando: 3d dance generation via actor-critic gpt with choreographic Memory, In CVPR, 2022; and in Zhang et al., T2m-gpt: Generating human motion from textual descriptions with discrete representations, In CVPR, 2023.

The motion encoder 402 and the motion decoder 404 can each be composed of 1D convolution layers (Conv1D). In an example embodiment, the motion encoder 402 and motion decoder 404 can use two stride-2 convolutions and two 2 upscaling layers each, setting an example upscaling and downscaling rate 1 to 4. FIG. 4B shows an example residual network (ResNet1D) layer 410.

An input motion X∈ [symbol] ^{T×d} can be encoded by the motion encoder 402 in Z=E_{conv}(X)∈ [symbol] ^{T}^{_{z}}^{×d}^{_{V}}, which can then be quantized by the quantization module 406 in \hat{Z}∈ [symbol] ^{T}^{_{z}}^{×d}^{_{V}}. Here, l denotes the temporal down-scaling factor of the mapping, T_{z} [T/l] denotes the length of the downscaled motion in the latent space, and d and d_{V} denote the dimensions of the single-frame human pose representation and the quantized latent space, respectively. \hat{Z} is reconstructed as \hat{X}∈ [symbol] ^{T×d} by the motion decoder 404.

Quantization and optimization: An example quantization Q aligns with a discrete codebook V={v₁, . . . , v_{C}}, where C represents the number of codes in the codebook and vᵢ∈ [symbol] ^{d}^{_{V}}. Example codebooks and methods for quantizing to align with a codebook are disclosed in U.S. patent application Ser. No. 17/956,022, filed Sep. 29, 2022. In an example, each element zᵢ of a latent vector sequence Z=E_{conv}(X)={z₁, . . . , z_{T}_{_{z}}} is quantized into the closest codebook entry vₛ_{ᵢ}, with the corresponding codebook index sᵢ∈{1, . . . , C}.

Thus, the example VQVAE 400 can be represented by the following equation:

$$\hat{Z} = Q ( Z ) := {[ arg {min}_{{v}_{{s}_{i}}} {‖ {z}_{i} - {v}_{{s}_{i}} ‖}_{2} ]}_{i} ∈ {ℝ}^{{T}_{z} \times {d}_{V}} \qquad ( 1 )$$

$$\hat{X} = {D}_{c o n v} ( \hat{Z} ) = {D}_{c o n v} ( Q ( {E}_{c o n v} ( X ) ) ) . \qquad ( 2 )$$

### Training the VQVAE

Equation (2) is non-differentiable, and thus in an example method can be addressed by the straight-through gradient estimator. During a backward pass, an example method approximates the quantization step as an identity function, copying gradients from the decoder to the encoder, e.g., as disclosed in Bengio et al., Estimating or propagating gradients through stochastic neurons for conditional computation, arXiv preprint, arXiv:1308.3432, 2013. This allows the training of the motion encoder 402, motion decoder 404, and the codebook 406 in the VQVAE through optimization by the following loss:

$${ℒ}_{V Q} = {ℒ}_{r e c o n} ( X , \hat{X} ) + {‖ sg [ {E}_{c o n v} ( X ) ] - \hat{Z} ‖}_{2}^{2} + β {‖ sg [ \hat{Z} - E ( X ) ] - \hat{Z} ‖}_{2}^{2} . \qquad ( 3 )$$

The term

$$β {‖ sg [ \hat{Z} - E ( X ) ] - \hat{Z} ‖}_{2}^{2}$$

is referred to as a commitment loss, which is useful for stable training, e.g., as disclosed in Van Den Oord et al., Neural discrete representation learning, NeurIPS, 30, 2017. The example reconstruction loss [symbol] _{econ} is embodied in L1-loss on the parameter, reconstructed joint, and velocity.

Product quantization: To enhance the flexibility of the discrete representations learned by the motion encoder E_{conv}, example methods can employ a product quantization. For example each element zᵢ within Z=E_{conv}(X) may be divided into K chunks

$$( {z}_{i}^{1} , … , {z}_{i}^{K} ) ,$$

with each chunk discretized separately using K different codebooks. The size of the learned discrete latent space increases exponentially with K, resulting in a total of C^{TK} combinations, where C is the size of each codebook. The increase in T and K provides a positive gain in both reconstruction quality and diversity, but in some instances may make mapping text to latent space more challenging. This can be addressed using example mapping methods as described below.
   Mapping a Text onto Discrete Latent Space

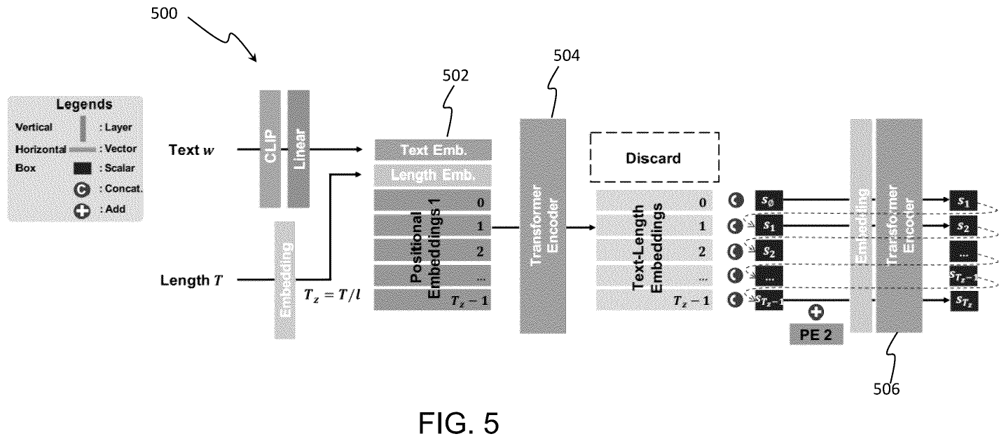

FIG. 5 shows an example text encoder 500, which is embodied in an attention-based, e.g., transformer-based, text encoder that is configured and trained to predict a sequence of indices in discrete latent space given an input text w, and optionally also a desired motion length T. At train time, target sequences are obtained using the trained VQVAE 400 by encoding ground truth target motions. Features of example transformers are provided U.S. Pat. No. 10,452,978, and in Vaswani et al., Attention is all you need, In Advances in Neural Information Processing Systems 30, pages 5998-6008, 2017.

The example input text is of variable dimension, a-priori independent of the length of the corresponding motion. Generally, example training methods embed the conditioning signals 502 and use a first transformer block 504 to inject that information into a sequence of T_{z} positional embeddings, as illustrated in FIG. 5. Here, T and T_{z} denote the desired length in motion space and downscaled length in motion latent space, respectively. This yields a sequence of T_{z} vectors, which are all functions of the input text and length. A second transformer block 506, which is causal, then uses this information to perform autoregressive next index prediction, ultimately obtaining the predicted index sequence.

Text Encoder Model: As illustrated in FIG. 5, the example text encoder includes two transformer layers, H₁ 504 and H₂ 506. To form the input for H₁, an example method first encodes the text through a CLIP layer, e.g., as disclosed in Radford et al., Learning transferable visual models from natural language supervision. In International Conference on Machine Learning (ICML), 2021, and a linear layer into eₜₑₓₜ∈ [symbol] ^{R}^{_{H}}. The desired length T is then embedded through an embedding layer Iₗₑₙ into eₗₑₙ∈ [symbol] ^{d}^{_{H}}. Here, dH denotes the input dimension of the example transformer layers.

An example method concatenates eₜₑₓₜ and eₗₑₙ, along the time dimension, following with positional embedding vectors PE₁∈ [symbol] ^{T}^{_{z}}^{×d}^{_{H}} representing the temporal dimension in motion latent space 502. This is used as input to H₁; the first two outputs along the time dimension may be discarded, obtaining the text-length embedding

$${\{ {e}_{t e xt - len}^{i} \}}_{i = 0}^{{T}_{z}} ∈ {ℝ}^{{T}_{z} \times {d}_{H}} = {H}_{1} ( {e}_{t e x t} , {e}_{len} , {PE}_{1} ) [ 2 : {T}_{z} + 2 ] . \qquad ( 4 )$$

The second transformer block 506 is used for autoregressive next index prediction. Given the previous indices,

$${\{ {s}_{i} \}}_{i = 0}^{t - 1} = ( {s}_{0} := {s}_{ϕ} , {s}_{1} , … , {s}_{t - 1} ) , and {\{ {e}_{text - len}^{i} \}}_{i = 0}^{t - 1} ,$$

example methods estimate the distribution

$$p ( {s}_{t} \vert {\{ {e}_{text - len}^{i} \}}_{i = 0}^{t - 1} , {\{ {s}_{i} \}}_{i = 0}^{t - 1} ) .$$

Each index

$${\{ {s}_{i} \}}_{i = 0}^{t - 1}$$

is embedded through the embedding layer I_{idx} into

$${\{ {e}_{idx}^{i} \}}_{i = 0}^{t - 1} ,$$

concatenated with

$${\{ {e}_{text - len}^{i} \}}_{i = 0}^{t - 1} .$$

The concatenated input is added with positional embedding PE₂∈ [symbol] ^{t×2d}^{_{H}} and passed to the transformer layer H₂ 506. The output corresponding to

$${e}_{idx}^{t - 1}$$

is then processed through a linear layer to estimate the likelihood,

$$p ( {s}_{t} \vert {\{ {e}_{text - len}^{i} \}}_{i = 0}^{t - 1} , {\{ {e}_{idx}^{i} \}}_{i = 0}^{t - 1} ) . \qquad ( 5 )$$

Example training methods can utilize a causal mask, such as disclosed in Lucas et al., Posegpt: Quantization-based 3d human motion generation and forecasting. In ECCV, 2022, and as disclosed in U.S. patent application Ser. No. 17/956,022, filed Sep. 29, 2022, to handle this process in a single forward pass. For example, a causal mask may be defined by an equation C_{i,j}= [symbol] i> [symbol] + [symbol] i≤j [symbol] . At test time, an example method can repeat the autoregressive sampling T_{z} times to obtain the final indices

$${\{ {s}_{i} \}}_{i = 1}^{{T}_{z}} .$$

This part of the example model (e.g., text encoder 500) can be trained to estimate the likelihood conditioned on the text and length input by minimizing the negative log-likelihood of the target indices under the output distribution.

### Generation of Long-term Motion

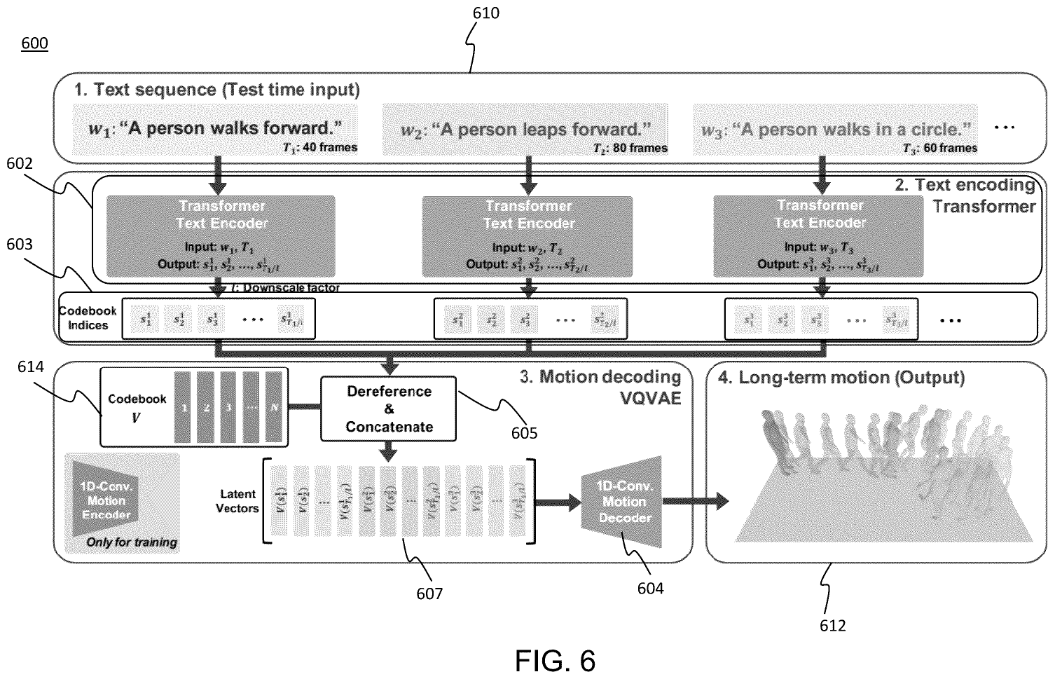

FIG. 6 illustrates an overview of an example operation of the long-term motion generation model 600, including the (e.g., transformer-based) text encoder 602, corresponding to text encoder 102 and 500, and the (e.g., VQVAE-based) motion decoder 604, corresponding to motion decoder 122 and 404, at runtime, e.g., test or inference time. For clarity, different notation will be used for illustrating motion generation.

Given a stream of sequential inputs

$${\{ ( {w}_{i} , {T}_{i} ) \}}_{i = 1}^{L}$$

610 of arbitrary length L, with wᵢ and Tᵢ corresponding to the i-th (i∈{1, . . . , L}) textual action description and desired motion length, respectively, and d the dimension of the single-frame human pose representation, an example method generates a corresponding realistic and smooth long-term motion 612, represented as a sequence of poses,

$${X}_{long} ∈ {ℝ}^{( {\sum }_{i = 1}^{L} {T}_{i} ) \times d} .$$

Each pair of elements (wᵢ, Tᵢ) is first individually passed to the (transformer-based) text encoder 602 to obtain a sequence

$$\{ {s}_{1}^{i} , … , {s}_{{T}_{i} / l}^{i} \}$$

of discrete pose indices 603, where 1 denotes the temporal down-scaling factor of the mapping. Next at 605, the extracted discrete pose indices

$${\{ {\{ {s}_{j}^{i} \}}_{j = 1}^{{T}_{i} / l} \}}_{i = 1}^{L}$$

603 are dereferenced using a structured index 614, e.g., the codebook V in the VQVAE, and concatenated into a continuous sequence of latent vectors 607. This provides the final input to the motion decoder 604:

$$Z = \{ V ( {s}_{1}^{1} ) , … , V ( {s}_{1}^{{T}_{i} / l} ) … , V ( {s}_{L}^{1} ) … V ( {S}_{L}^{{T}_{i} / l} ) . \}$$

Then, using a 1 D convolutional decoder D_{conv} 604, these latent vectors 607 are decoded to obtain the desired long-term motion 612:

$${X}_{long} = {D}_{conv} ( Z ) ∈ {ℝ}^{( {\sum }_{i = 1}^{L} {T}_{i} ) \times d} .$$

In example methods, the input of the convolutional decoder is a continuous stream of arbitrary length rather than independently generated actions that are later blended together.

Example systems and methods provide a continuous generation framework to overcome limitations of previous approaches. Such systems and methods vary from existing long-term generation methods in significant ways. For example, unlike conventional recurrent generation methods, example long-term motion generation models do not (or need not) train a motion posterior conditioned on past motion. Instead, present methods can utilize an autoencoder such as a VQVAE to learn a conditionless prior, enabling the learning of smooth motion transitions without the need for sequential data. Additionally, instead of decoding a single latent vector into an entire motion, e.g., using a Transformer layer, example methods herein can provide one-dimensional (1D) convolution to restrict the representative field of the latent vector to a fixed local region.

Example systems and methods herein thus provide various advantages for long-term motion generation. For instance, previous methods may encounter a square increase in memory and computing time when handling long sequences, limiting the ability to continuously decode long-term motion in a single batch. Present methods herein, in contrast can achieve continuous decoding, facilitating smoother transitions. Additionally, it can be more convenient to convey desired semantics at specific moments, leading to improved action quality compared to conventional methods representing variable-length actions with a single latent vector.

### Experiments

In experiments, an example VQVAE providing a motion decoder used a codebook of 512 dimensions, C=256 vectors in each K=2 book for product quantization. An example motion generation framework was implemented with PyTorch (Paszke et al., Automatic differentiation in pytorch, NeurIPS Workshop on Autodiff, 2017). The example text encoder was a Transformer with three layers, 2048 inner dimensions, and 16 multi-head attentions. AdamW (Loshchilov and Hutter, Decoupled weight decay regularization, In ICLR, 2018) was used as an optimizer with a learning rate of 2e−4 and 3e−4, respectively, for training the VQVAE and text encoder.

The VQVAE and the text encoder were trained for 1000 and 700 epochs, respectively, with a StepLR learning rate scheduler of step size 350 and a decrease rate of 0.5. The size of the mini-batch was set to 128. A linear interpolation augmentation was applied during VQVAE training, and a random corruption (Zhang et al., T2m-gpt: Generating human motion from textual descriptions with discrete representations, In CVPR, 2023) augmentation was applied for the text encoder. Training the experimental model took about 28 hours on a single Nvidia 2080Tᵢ GPU.

Long-term generation performance of example method and systems was compared with previous state-of-the-art methods. Experiments were conducted on two datasets: HumanML3D (Guo et al., Generating diverse and natural 3d human motions from text, In CVPR, 2022) and BABEL (Punnakkal et al., BABEL: Bodies, action and behavior with English labels, In CVPR, 2021). The HumanML3D dataset was used to illustrate the performance of an example motion generation model without sequential training datasets, emphasizing its effectiveness in long-term generation. With the BABEL dataset, an example approach was compared with existing long-term generation methods that rely on sequential data. Both datasets were evaluated using widely used evaluation protocols, as disclosed in Guo et al., Generating diverse and natural 3d human motions from text. In CVPR, 2022.

The HumanML3D dataset comprised 14,616 motions, each associated with 3-4 textual descriptions. These motions, sampled at 20 FPS, originated from the AMASS and HumanAct12 motion datasets, with manual additions of text descriptions. Training used motions with lengths ranging from a minimum of 40 frames to a maximum of 196 frames.

The experiments used the text version of the BABEL dataset, as disclosed in Athanasiou et al., TEACH: Temporal Action Compositions for 3D Humans, In 3DV, 2022. This dataset included 10,881 sequential motions, each annotated with textual labels for action segments. The motions were processed similarly to TEACH, using motions with lengths of a minimum of 44 frames to a maximum of 250 frames.

### Evaluation Metrics

Sliding-scope and Transition-scope: Existing evaluation metrics for motion generation rely heavily on extracting features from the entire motion, making them dependent on motion length and inadequate for quantitatively assessing the quality of generated long-term motions. To address this limitation, experiments used Frechet Inception Distance (FID) and Diversity within a Sliding-scope and Transition-scope as evaluation criteria.

A fixed window of 80 frames for both scopes was used to extract subsets of long-term motions. FID and Diversity (Div) were then measured by comparing these subsets with sets extracted identically from the ground truth motion set. For Sliding-scope (SS-FID and SS-Div), experiments slid this window with a stride of 40 frames from the beginning to the end of the generated long-term motion to extract samples. For the Transition-scope (TS-FID and TS-Div), samples were extracted that centered around transitions in the generated long-term motion.

The Sliding-scope provided an overall measure of how realistically the generated long-term motion represents the entire sequence. At the same time, the Transition-scope evaluated how smoothly and seamlessly the long-term motion portrays transitions between actions. The pre-trained feature extractor from Guo et al, Generating diverse and natural 3d human motions from text, In CVPR, 2022, was used to encode the representation of motion and text.

Experiments evaluated the quality of generated short-term action with R-precision, FID, MultiModal distance, and Diversity. Additionally, SS-FID and TS-FID were used to assess the quality of generated long-term motion quantitatively.

R-Precision: For each motion, experiments ranked the Euclidean distance to 32 text descriptions of 1 positive and 31 negatives. The Top-1, Top-2, and Top-3 accuracy were determined.

FID: Experiments further determined the Frechet Inception Distance (FID) between the set of ground truth motions and generated motions.

MM-Distance: The average Euclidean distances between the features of each text and motion were determined.

Diversity: The average Euclidean distances of the pairs in a set of 300 generated motions were determined.

### Ablation

Additional experiments considered the effect of an alternative method using a transition latent vector and of alternative configurations of the codebook in VQVAE. Quantitatively, these experiments were conducted using five metrics: FID_{VQ}, R-Prec., FID, Diversity, and TS-FID. FID_{VQ} represented the FID score of the reconstructed motion by the VQVAE.

Transition latent vector: To avoid the need for long-term data, example methods can rely on transition tokens, which are designed to chain sequences together at inference. Such transition tokens can be obtained by masking at training time.

Experiments considered two example ways of chaining a stream of latents from different texts at inference time. The first approach was by concatenating the features, e.g., by relying on extra frames and corresponding latent vectors to connect consecutive actions together. The other approach used an additional token in the VQVAE codebook to denote transitions. For the latter option, example methods added the learnable transition vectors in between latents of each text:

$$V ( {s}_{⌊ {T}_{i} / l ⌋}^{i} ) and V ( {s}_{1}^{i + 1} )$$

an inference time as shown in FIG. 6 and described by example above. To train these transition latent vectors, an example method randomly substituted part of the quantized latent vectors Z into the transition latent vectors while training the VQVAE.

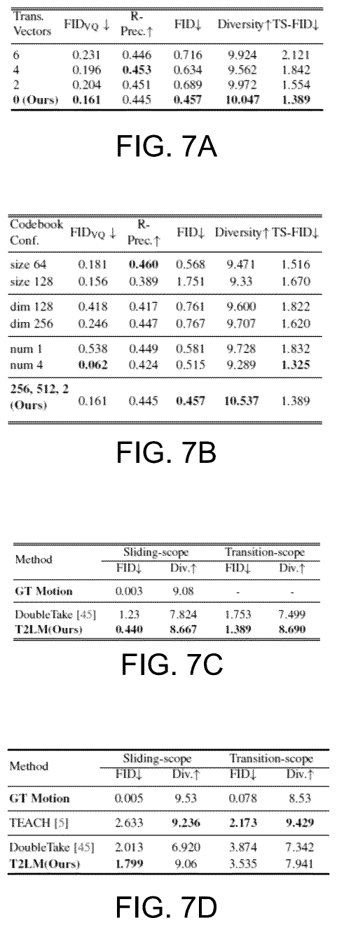

FIG. 7A shows experimental results. In FIG. 7A, the leftmost column indicates the size of transition vectors. The length of the additional transition was 2×1 if two transition vectors were used, where l denotes the scaling rate of the VQVAE. A decrease in performance was observed as the size of transition latents increased in four metrics. The decrease in FID and Diversity, reflecting single-action quality, signaled a reduction in the representation power of the latent space during transition latent training, which is illustrated from the decrease in VQVAE's reconstructed motion, as indicated by FID_{VQ}. While using a transition latent vector was effective, the experiments suggested that, when sequential datasets are not employed, methods using concatenation may provide improved results over use of transition latent vectors, while being more straightforward to implement.

Codebook configuration: FIG. 7B illustrates experimental quantitative measures for various codebook configurations used in the example VQVAE. An increase in the complexity of the codebook generally resulted in better performance of VQVAE reconstruction, but at the expense of more complicated predictions for the latent sequence prediction model. Increasing codebook complexity was not found to lead to monotonously improving final generations, which is visible, e.g., when using four codebooks. While the configuration including complexity of the codebook can vary, and the example configurations provided are not exhaustive, good results were provided using an example codebook setting with 2 codebooks, 256 vectors each, and 512 dimensions.

### Comparison to Other Methods

Experiments compared the quality of motions generated with long-term motion generation methods (e.g., T2LM) according to example methods herein to previous methods on the HumanML3D and BABEL datasets. For the experiments on BABEL, the example T2LM model was trained with individual actions and text annotations without using transitions. The experimental comparison target was DoubleTake, as disclosed in Shafir et al., Human motion diffusion as a generative prior, arXiv preprint arXiv:2303.01418, 2023. DoubleTake is a long-term generation method trained without sequential data.

Long-term motion generation: Figures FIGS. 7C and 7D illustrate comparative results for long-term motion on HumanML3D and BABEL test sets respectively. Example T2LM methods outperformed DoubleTake in every criteria on both test sets. In the Sliding-scope evaluation, example T2LM models demonstrated better overall quality of generated long-term motion compared to DoubleTake. In the Transition-scope evaluation, example T2LM models produced more realistic transitions than those generated by DoubleTake.

When evaluating long-term generation on the BABEL dataset, example T2LM models outperformed TEACH in the SS-FID metric, indicating better overall quality. While the example T2LM models showed inferior performance in the Transition-scope evaluation, this can be attributed to the usage of transitions from BABEL in TEACH during training time, while example T2LM models trained with individual actions only.

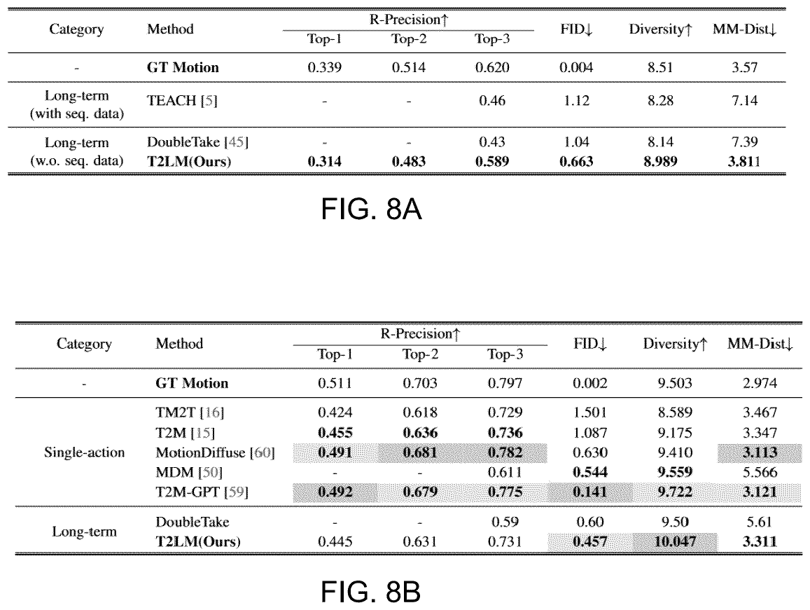

Single-action generation: FIGS. 8A and 8B show a comparison of the generation performance of a single action to previous state-of-the-art methods for Single-action on BABEL and HumanML3D test sets, respectively. In FIG. 8B, the best, second, and third results are denoted in red, orange, and yellow, respectively. FIGS. 8A-8B illustrate that show that example T2LM methods outperformed previous long-term generation methods by a large margin on both HumanML3D and BABEL. The example T2LM method scored 14.1% higher in Top-3 R-precision compared to DoubleTake on HumanML3D. Further, the example T2LM models gained 0.159 and 0.129 in Top-3 R-precision over DoubleTake and TEACH, respectively, on BABEL. Compared to short-term generation models, example T2LM models achieved a performance comparable to current state-of-the-art methods. For instance, the example T2LM method achieved the second-best performance measured with the FID score, with 0.457, the best Diversity score with 10.047, and the third-best MM-Dist. Score with 3.311. In the example T2LM method, the localized representative regions of each latent vector, combined with the example text encoder effectively conveying semantics from the text to the corresponding temporal dimensions, is believed to contribute to this improved performance.

In general, the experiments demonstrated that example T2LM methods, though being straightforward to implement, outperformed previous long-term generation methods in both single-action and long-term generation despite not requiring any sequential data for training. Such example methods were also demonstrated to match single-action generation models on the quality of generated actions.

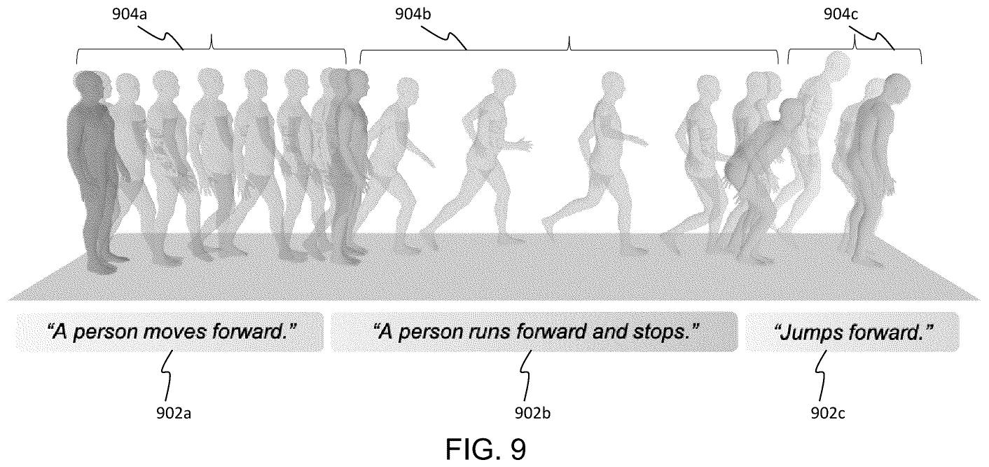

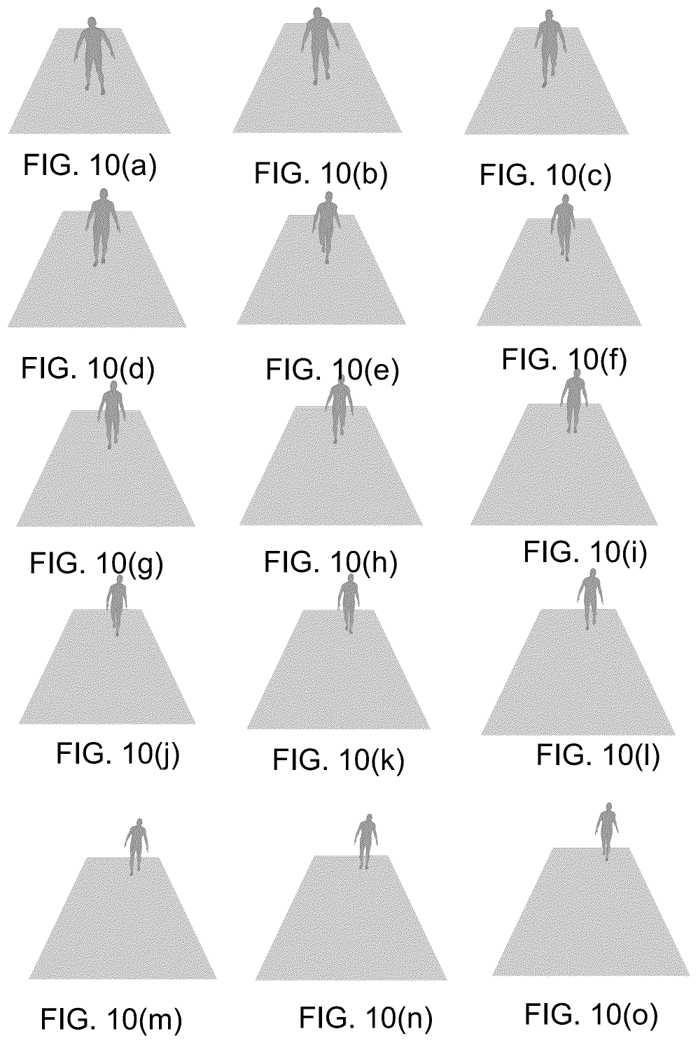

Qualitative result: FIG. 9 shows an example visual result obtained from an example long-term motion generator model, where a stream of input texts 902 was used to condition the model, and the model produced a matching continuous motion from a sequence of generated poses 904. In FIG. 9, the example input text included the phrases “A person moves forward” 902a→“A person runs forward and stops” 902b→“Jumps forward” 902c.

Additional experiments generated example long-term motion videos from various text inputs. Three example text inputs used included the following: 1) “Wave hand”→“Walks in a circle”→“Runs forward”; 2) “Walks forward fast”->“Walks back”→“Putting a golf ball”; 3) “Walks backward, then walk forward to original position”→“Raise both arms and squat”→“Walks forward a couple steps, then turn back, walk back to the original position”. In the experiments, the original video was rendered in 24 FPS, while the Figure represents frames after downsampling the original (24 FPS) video into 6 FPS and then displaying it in 15 FPS.

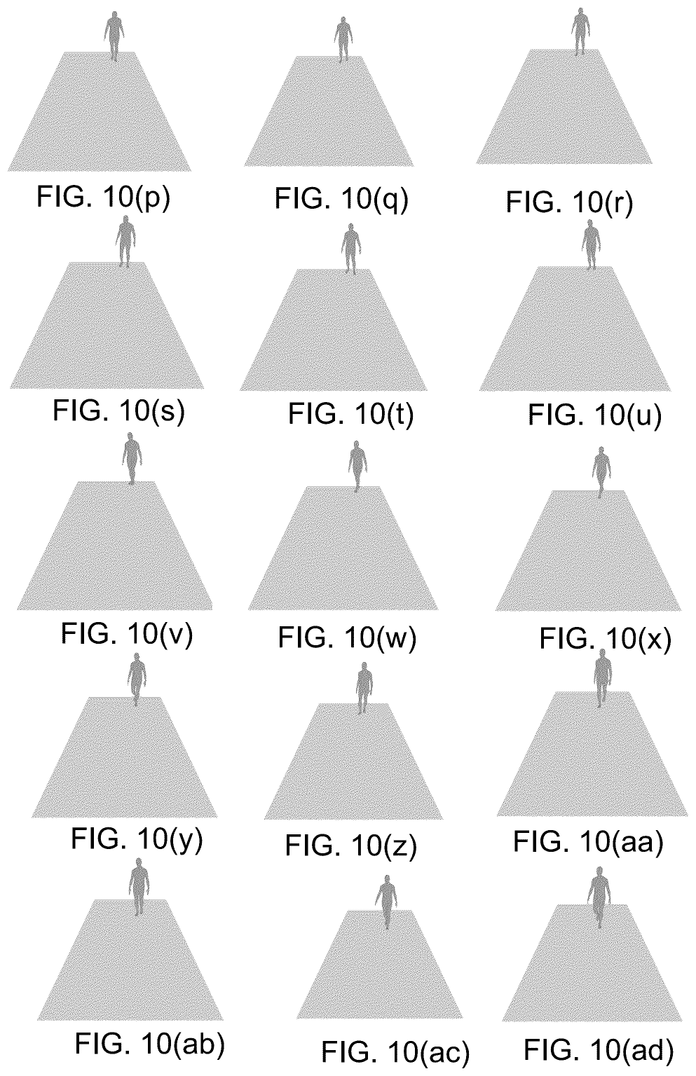

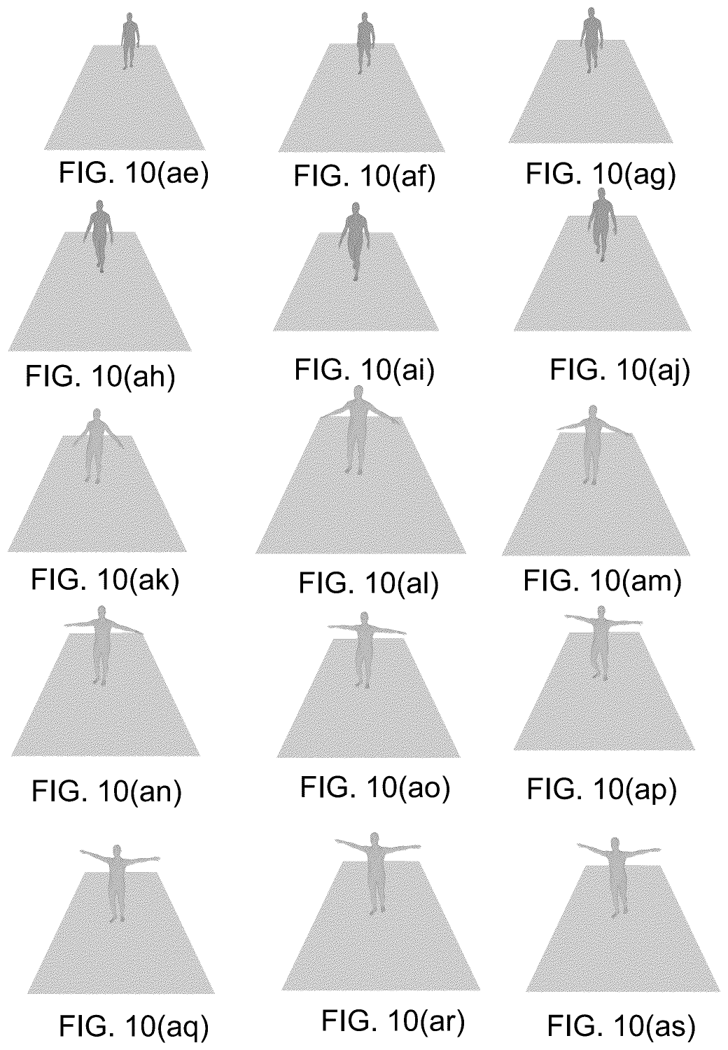

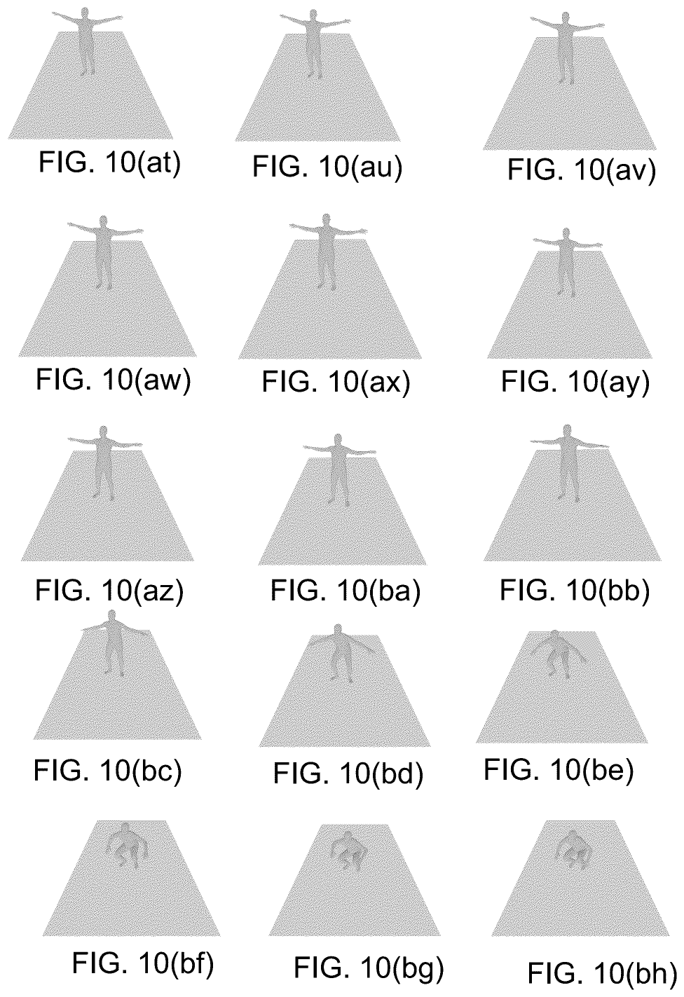

FIGS. 10(a)-10(bh) shows a sequence (letter order corresponding to forward in the sequence) of video frames from a portion of an example visualization of generated long-term motions obtained with an example method in response to the third example text input above: “Walks backward, then walk forward to original position”→“Raise both arms and squat”→“Walks forward a couple steps, then turn back, walk back to the original position.” The first action (“Walks backward, then walk forward to original position”) is shown in the frames in FIGS. 10(a)-10(aj), and a portion of the second action (“Raise both arms and squat”) are shown in the frames in FIGS. 10(ak)-10(bh) (rendered in blue and purple, respectively). The generated frames illustrate a smooth transition between actions (i.e., the method is able to coarticulate actions (e.g., standing up and turning around)).

Qualitative comparisons using generated motion further demonstrated that an example long-term motion generation method herein can generate a higher-quality long-term motion. For example, generated actions from the experimental methods were clearer, better followed the given description, and the feet were more stable on the ground, that comparative methods. Moreover, the experimental generated transitions are smoother without an unrealistic gap and realistically connect between consecutive actions.

The experimental models according to example methods herein generated continuous and realistic walking movement from sequential inputs “walk” and “walk straight” in qualitative comparisons, while the compared methods generated unrealistic stopping in between walking. Further, and surprisingly, example methods herein generated fine transitions between semantically and physically far actions such as “lift up” and “walk”. The visualized long-term motions in these experiments were generated from input text sequences of length 6, though example models can process arbitrarily long input sequences.

The example visualizations demonstrated that example models according to methods herein can generate realistic long-term motion with high-quality actions and realistic transitions. The generated actions in experiments were of high quality and precisely followed the descriptions even for complex inputs such as “the toon has both arms raised at an angle above their head, as to be in the squatting motion for exercise” and “a person jogs around in a semi-circle and then back, before walking.”

Additional experiments were conducted to assess the effect of learning rates and the number of layers in an example ResNet1D and an example text encoder. For both VQVAE and text encoder blocks, model training may be affected by the learning rate. Nonlimiting example learning rates for training an example model are 2e−4 and 3e−4 for the VQVAE and the Text Encoder, respectively. It was also observed that increasing the number of layers in the ResNet1D and Text Encoder may lead to improved performance for some metrics. As a nonlimiting example, the model may be formed with 4 layers in ResNet1D, and 4 layers in the Transformer-based Text Encoder, respectively.

In sum, experiments using the example models achieved state-of-the-art performance compared to previous long-term generation methods on both actions and transitions. Furthermore, the single-action quality of example models was comparable to previous state-of-the-art single-action generation methods.

### Advantages and Applications

Example approaches herein can provide any of several advantages for long-term generation. Example long-term motion generation methods herein can handle a long sequence continuously at once, generate smoother transitions, and can effectively convey the desired semantics at specific moments. Providing a local representative field, e.g., with linear time and computational complexity, allows an example model to continuously handle a long sequence at once. By contrast, previous methods using transformers encounter a square increase in memory and computing time when handling long sequences, limiting the ability to continuously decode long-term motion in a single batch. Example methods can achieve better quality of action compared to conventional methods representing variable-length actions with a single latent vector.

Example methods can produce sequences of latent vectors, unlike other approaches that encode the entire sequence into a single latent vector. Further, example methods can learn a prior over small chunks of motion, each encoded independently from the others, such as by using a VQVAE encoder built from 1D convolutional layers with a local receptive field. The 1D convolution can be utilized to restrict the representative field of the latent vector to a fixed local region.

These features offer several advantages for long-term motion generations. Example models can process a sequence of up to infinite length on the fly, since the cost of forwarding the model can be linear in the size of the local receptive field. This reduced required computational complexity allows example models to continuously decode long-term motion in a single batch, in contrast, for instance, with methods that employ a standard transformer architecture with a complexity that is quadratic in the sequence length. Example models further can process a continuous stream, rather than a sequence of chunks that have to be later post-processed as in some conventional methods. Example methods can generate a smoother transition. Further, using a sequence of latent vectors with local receptive fields allows example models to convey fine-grained semantics at the right temporal location. These features provide, among other benefits, higher-quality actions compared to existing methods that generate variable-length actions with a single latent vector.

Experiments show that example models herein can outperform state-of-the-art methods on long-term generation while matching or outperforming existing approaches for single-action when evaluated with FID scores and R-precision. Evaluation using metrics designed to better assess the quantitative quality of long-term motions both around transitions and along the sequence through a sliding window scheme demonstrated that example methods herein can achieves improved performance over conventional long-term motion generation methods.

Example methods can connect actions in latent space and then decode, rather than providing sequentially generated actions as input for subsequent steps or concatenating them. These features can provide, among other benefits, the creation of more realistic transitions and long-term motion. Further, in contrast to other approaches where each step may utilize one latent vector to generate a whole action of variable length, example methods herein can fix the receptive field of each latent vector to constant size. Qualitative and quantitative comparisons demonstrate that example continuous approaches herein can produce motion of higher quality and realism compared to conventional recurrent methods.

Generating plausible long-term human motion can be used in various applications. Nonlimiting example applications of generated long-term motion include navigation, simulation, media creation, augmented reality, mixed reality, virtual reality, autonomous movement, and others. The capability of example methods and systems to generate plausible long-term human motion allows such methods and systems to be suitable for these and other applications.

For instance, in navigation, it is desirable for embodied AI systems to detect surrounding persons (or other animals or automated machines such as robots) and predict their future motions such that they can adapt their behaviors in the environment. An embodied AI, for instance, can observe human motion and predict possible futures that make sense in a given environment to successfully interact with humans. In alternate embodiments, embodied AI may be tailored to observe other nonhuman motion and predict futures that make sense in a given environment to successfully interact with nonhumans.

As another example, mobile autonomous device (e.g., robot or autonomous vehicle) navigation in crowded scenes requires robots or autonomous vehicles to achieve their tasks without perturbing or hurting the people around them. Example long-term motion generation can be integrated, for instance, in a collision avoidance pipeline for a robot or autonomous vehicle to safely move in crowded environments. Another example application is co-navigation, where a robot and autonomous vehicle may follow or guide a user.

Example systems and methods can be used to generate long-term motion for simulators, e.g., to produce datasets of human motions for training autonomous navigation. An example simulator may be used, e.g., for training a mobile autonomous device such as a robot or autonomous vehicle to navigate within an environment with people.

Other example applications include animating avatars and creating synthetic content. For AR/VR/MR, media creation (e.g., video or gaming content generation), or other applications, example systems and methods could be used to animate avatars or other virtual humans, creating synthetic content, including but not limited to media such as video or games, where frames representing long-term motion can be directly created, edited, or animated. The ability to condition human motion on raw input text as in some example methods and systems provides a relatively easier way to control avatars. By generating smooth transitions, a user can generate human motion on the fly without the need to start from scratch.

Outputs of example models can also be used for downstream applications such as but not limited to generation of a sequence of 3D meshes, e.g., by providing pose parameters to a model such as SMPL-X (Pavlakos et al., Expressive body capture: 3d hands, face, and body from a single image, In CVPR, 2019). In other embodiments, given a 3D mesh known blenders such as clothing blender may be used to add clothing to a target mesh to generate clothed target mesh. In addition, a 3D scene blender may be used to insert the clothed target mesh into a scene to generate 3D scene. In yet other embodiments, human body meshes can be animated, enhancing the realism and interaction in augmented and virtual reality (AR/VR) environments.

### Network and Hardware System

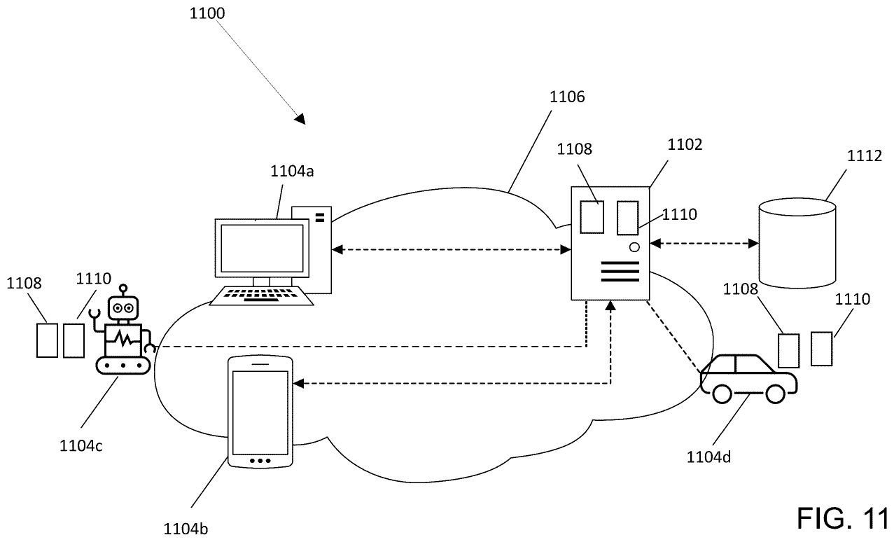

Example systems, methods, and embodiments may be implemented within a system 1100 or a portion thereof such as illustrated in FIG. 11. The system 1100 may comprise a server 1102 and/or may comprise one or more devices such as devices 1104. The devices 1104 may operate as client devices and may communicate over a network 1106 which may be wireless and/or wired, such as the Internet, for data exchange, or may operate as standalone devices (or even disconnected from the server 1102 entirely).

The server 1102 and the devices 1104 can each include a processor, e.g., processor 1108, and a memory, e.g., memory, such as but not limited to random-access memory (RAM), read-only memory (ROM), hard disks, solid state disks, or other non-volatile storage media. Memory 1110 may also be provided in whole or in part by external storage in communication with the processor 1108.

The system 100, 600, the autoencoder 120 (e.g., VQVAE 400, 614), and/or the text encoder 500, 602, for instance, may be provided in the server 1102 and/or one or more of the devices 1104. In some example embodiments, the system 100, 600 e.g., after training according to example methods, may be provided in the server 1102 and/or devices 1104, possibly without the training module 140 (or, possibly, without the motion encoder 126 in the trained autoencoder), and/or the training module 140 may be provided in the devices 1104 and/or the server 1102. In other example embodiments, the server 1102 may train the system 100, 600, or a portion (e.g., the autoencoder 120, 400, 614) or may pretrain the system offline, and the system may then be provided in one or more of the devices, or the system may be integrated into a system in the devices and partially or end-to-end trained.

It will be appreciated that the processor 1108 in the server 1102 or any of the devices 1104 can include either a single processor or multiple processors operating in series or in parallel, and that the memory 1110 in the server 1102 or any of the devices 1104 can include one or more memories, including combinations of memory types and/or locations. Server 1102 may also include, but are not limited to, dedicated servers, cloud-based servers, or a combination (e.g., shared). Storage, e.g., a database, may be embodied in suitable storage in the server 1102, device 1104, a connected remote storage 1112 (shown in connection with the server 1102, but can likewise be connected to client devices), or any combination.

Devices 1104 may be any processor-based device, terminal, etc., and/or may be embodied in an application executable by a processor-based device, etc. Example devices include, but are not limited to, autonomous devices, media or display devices, or interactive devices. Devices 1104 may operate as clients and be disposed within the server 1102 and/or external to the server (local or remote, or any combination) and in communication with the server, or may operate as standalone devices, or a combination.

Example devices 1104 include, but are not limited to, autonomous computers 1104a, mobile communication devices (e.g., smartphones, tablet computers, etc.) 1104b, robots 1104c, autonomous vehicles 1104d, wearable devices, virtual reality, augmented reality, or mixed reality devices (not shown), or others. Devices 1104 communicating with the server 1102 may be configured for sending data to and/or receiving data from the server, while other devices 1104 may be standalone devices. Devices may include, but need not include, one or more input devices, such as image capturing devices or input interfaces, and/or output devices, such as for communicating, e.g., transmitting, displaying, controlling, etc., actions determined through navigation methods. Devices may include combinations of client devices.

In example training methods, the server 1102 or devices 1104 may receive a dataset from any suitable source, e.g., from a memory 1110 (as nonlimiting examples, internal storage, an internal database, etc.), from external (e.g., remote) storage 1112 connected locally or over the network 1106. For long-term motion generation training, or a portion thereof (e.g., autoencoder or text encoder training), devices 1104 may receive (e.g., non-sequential) of (e.g., single) actions and associated text, possibly further including synthetic datasets. The example training methods can generate a trained model or portion thereof that can be likewise stored in the server (e.g., memory 1110), devices 1104, external storage 1112, or combination. In some example embodiments provided herein, training may be performed offline or online (e.g., at run time), in any combination.

The example system 100, 600 shown in FIG. 1 or 6 or portions thereof, shown in FIGS. 4A, 4B, and 5, may be incorporated into a device such as an autonomous apparatus (e.g., vehicle 1104d or robot 1104c), interactive device, computer, display, mobile device, AR/VR device, etc., and/or in a server or remote processor in communication with such devices. The system 100, 600 may comprise an input device such as described herein, for providing a text input for 3D motion generation. The text input may also in some examples be provided from or forwarded through one device, e.g., via a network, or wired or wireless communication, and processed by another device for generating long-term motion.

An example device, such as but not limited to an autonomous device, alone or via communication with another device 1104 or server 1102, may train, e.g., using training module 140, a system 100, 600 embodied in a machine learning model for a downstream task. Alternatively, the device may receive directly or indirectly from the server 1102 or elsewhere a trained system trained by the server, e.g., using training module 140 (or similar model for system 100, 600) or by another device. Models may be updated or fine-tuned. Updated models including parameters may be stored in memory 1110.

The device may apply the trained machine learning model to receive one or more text inputs as needed to generate long-term motion. The device may then adapt its display, e.g., display 134, or other interface, and/or adapt its motion state (e.g., velocity or direction of motion) or other actuating operation based on the generated 3D meshes. For example, the controller 136 may be configured to control operation of the actuator 128, e.g., a propulsion device, to navigate the autonomous apparatus to perform a downstream task based on the presence of generated motion of an entity (e.g., a human or robot) in an environment.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

Embodiments of the invention provide, among other things, a method for training a model for generating a representation of long-term motion from a text input, where the long-term motion comprises a plurality of consecutive actions and a transition between each consecutive pair of the plurality of consecutive actions, the method comprising: training an autoencoder, the training comprising: training a motion encoder of the autoencoder to compress and map an input motion into a latent representation comprising a sequence of latent vectors in a discrete latent space, each latent vector representing a fixed length of motion; training a quantization module of the autoencoder to quantize the sequence of latent vectors to a sequence of quantized latent vectors in quantized latent space; and training a motion decoder of the autoencoder to reconstruct the quantized sequence of latent vectors as a sequence of single-frame pose representations; and training a text encoder connected to the trained autoencoder to predict a latent sequence conditioned on a text input and a duration using the mapped latent representation generated by the trained motion encoder as a target; wherein training the autoencoder and training the text encoder both use a dataset of single actions and associated text; wherein, in the trained model, the trained text encoder receives a text input comprising a plurality of phrases, where each phrase describes an action, and processes the received text input and a received duration to predict a latent sequence, the trained quantization module quantizes the latent sequence from the predicted latent sequence, and the trained motion decoder decodes the quantized latent sequence to output parameters for generating the representation of long-term motion; and wherein the representation of long-term motion is provided for one or more of (a) display on at least one display, and (b) control of at least one autonomous device. In combination with any of the above features in this paragraph, the autoencoder may comprise a vector quantization variable autoencoder (VQVAE). In combination with any of the above features in this paragraph, the representation of long-term motion may comprise a plurality of frames, each frame comprising a three-dimensional representation of an entity. In combination with any of the above features in this paragraph, the three-dimensional representation may comprise a mesh or skeleton of the entity defined by 3D points or parameters. In combination with any of the above features in this paragraph, the entity may be a human. In combination with any of the above features in this paragraph, the entity may be a robot. In combination with any of the above features in this paragraph, training an autoencoder may use a gradient estimator. In combination with any of the above features in this paragraph, training an autoencoder may use a reconstruction loss; wherein the reconstruction loss may comprise an L1-loss, a reconstructed joint loss, and/or a velocity. In combination with any of the above features in this paragraph, the VQVAE may be trained further using a commitment loss. In combination with any of the above features in this paragraph, the motion encoder and the motion decoder each may comprise a 1D-convolutional layer with a local receptive field, the 1D-convolutional layer determining a temporal down-scaling factor for mapping. In combination with any of the above features in this paragraph, the input motion may comprise a sequence of single-frame pose representations for each duration, the sequence of latent vectors comprising a sequence of vectors in quantized latent space for each scaled motion length. In combination with any of the above features in this paragraph, quantizing the sequence of quantized latent vectors in quantized latent space may be based on closest stored latent vectors, the stored latent vectors being stored as entries in one or more codebooks. In combination with any of the above features in this paragraph, quantizing the sequence of quantized latent vectors in quantized latent space may be based on closest stored latent vectors, the stored latent vectors being stored as entries in a plurality of codebooks. In combination with any of the above features in this paragraph, in the text input received by the trained text encoder, the plurality of phrases may have a length that is independent of lengths of corresponding motions. In combination with any of the above features in this paragraph, the plurality of phrases may comprise a plurality of sentences. In combination with any of the above features in this paragraph, the duration may comprise a motion length in motion space. In combination with any of the above features in this paragraph, the text encoder may comprise an embedding module for positionally embedding the input text and the duration, an attention-based block for injecting information about the text and duration embeddings into a sequence of tokens, and an autoregressive block for predicting the latent sequence. In combination with any of the above features in this paragraph, the attention-based block may comprise a transformer-based encoder; and the autoregressive block may comprise a transformer-based model configured to autoregressively sample next indices. In combination with any of the above features in this paragraph, the embedding module may be configured to: encode the input text; embed the duration; and concatenate the encoded input text with the embedded duration along a time dimension, and with positional embedding vectors representing a temporal dimension in latent space. In combination with any of the above features in this paragraph, training the text encoder may comprise: training the transformer-based encoder to generate a sequence of text-length embeddings from the positionally embedded input text and duration; and training the autoregressive block for autoregressive next index prediction from the sequence of text-length embeddings to generate the latent sequence; wherein training the text encoder uses a causal mask.

Additional embodiments of the invention provide, among other things, a method for generating a long-term motion representation, the long-term motion comprising a plurality of consecutive actions and a transition between each consecutive pair of the plurality of consecutive actions, the method comprising: receiving a text input comprising a plurality of phrases, each phrase describing an action, wherein the plurality of phrases have a length that is independent of the length of a corresponding motion; receiving one or more durations, the durations comprising a motion length for each action; generating the long-term motion representation conditioned on the text input and the durations, wherein generating comprises: predicting, using the text input and the durations, a latent representation comprising a continuous stream of latent vectors, each latent vector representing a fixed length of motion, each latent vector comprising a vector in a discrete latent space; and decoding the latent representation comprising the predicted continuous stream of latent vectors using a motion decoder to continuously reconstruct the long-term motion representation, the motion decoder being a decoder of an autoencoder trained to compress motion to sequences of latent vectors, the autoencoder comprising the motion decoder and a quantization module, the autoencoder during training further comprising a motion encoder; and providing the long-term motion representation conditioned on the text input and the durations for one or more of (a) display on at least one display, and (b) control of at least one autonomous device. In combination with any of the above features in this paragraph, the long-term motion representation may comprise a plurality of frames, each frame comprising a three-dimensional (3D) pose representation of an entity. In combination with any of the above features in this paragraph, each pose representation of the entity may comprise 3D points representing a mesh and/or model parameters for producing 3D pose representations. In combination with any of the above features in this paragraph, the text input may comprise a plurality of sentences. In combination with any of the above features in this paragraph, the received durations may be provided as an input, sampled from a prior, or a combination. In combination with any of the above features in this paragraph, predicting may comprise encoding the text input and the durations using a text encoder to predict a continuous stream of indices in discrete latent space, the text encoder may be trained to map the text input and the duration to the continuous stream of indices; and the text encoder and the autoencoder may both be trained with a dataset of single actions and associated text. In combination with any of the above features in this paragraph, the text encoder may comprise an autoregressive encoder. In combination with any of the above features in this paragraph, the autoregressive encoder may be a transformer-based encoder. In combination with any of the above features in this paragraph, the text encoder may further comprise an attention-based encoder for positionally embedding the text input and the durations. In combination with any of the above features in this paragraph, the attention-based encoder may be a transformer-based encoder. In combination with any of the above features in this paragraph, the indices may comprise codebook indices associated with entries in one or more codebooks of stored latent vectors in a discrete latent space. In combination with any of the above features in this paragraph, the one or more codebooks may comprise a plurality of codebooks. In combination with any of the above features in this paragraph, encoding the text input and the durations may comprise: embedding the text input and the durations; injecting, using an attention-based block, the embedded text input and the duration into a sequence of positional embeddings; and predicting, using an autoregressive attention-based block, the continuous stream of indices. In combination with any of the above features in this paragraph, the number of positional embeddings in the sequence may be based on a motion length, wherein the motion length may be downscaled. In combination with any of the above features in this paragraph, the method may further comprise: dereferencing each of the predicted indices in the stream by quantizing the predicted indices to closest stored latent vectors in the discrete latent space to determine the latent vectors; and concatenating the determined latent vectors to provide the continuous stream of latent vectors. In combination with any of the above features in this paragraph, the continuous stream of latent vectors may have an arbitrary length with respect to the plurality of consecutive actions. In combination with any of the above features in this paragraph, the autoencoder may comprise a vector quantization variable autoencoder (VQVAE). In combination with any of the above features in this paragraph, the motion decoder and the motion encoder may each comprise a 1D-convolutional layer with a local receptive field. In combination with any of the above features in this paragraph, the representation of long-term motion may comprise a plurality of frames, each frame comprising a three-dimensional representation of an entity; wherein the entity may be a human or a robot. In combination with any of the above features in this paragraph, each latent vector may represent an entire action, less than an entire action, or more than an entire action.

Additional embodiments of the invention provide, among other things, a processor-based system for generating a long-term motion representation, the long-term motion comprising a plurality of consecutive actions and a transition between each consecutive pair of the consecutive actions, the system comprising: a text encoder configured to: receive a text input comprising a plurality of phrases, each phrase describing an action, wherein the plurality of phrases have a length that is independent of the length of a corresponding motion; receive one or more durations, the durations comprising a motion length for each action; and predict a set of pose indices referencing a latent representation comprising a continuous stream of latent vectors, each latent vector representing a fixed length of motion, each latent vector comprising a vector in a discrete latent space; a motion decoding autoencoder configured to: dereference the set of pose indices and concatenate the continuous stream of latent vectors to provide a sequence of quantized latent vectors in quantized latent space; and decode the sequence of quantized latent vectors to generate the long-term motion representation; and a device using the long-term motion representation for one or more of (a) visual display on at least one display, and (b) control of at least one autonomous device. In combination with any of the above features in this paragraph, the autoencoder and the text encoder may be trained using a dataset of single actions and associated text. In combination with any of the above features in this paragraph, the autoencoder, when it is trained, may further comprise: a motion encoder configured to compress and map an input motion into a latent representation comprising a sequence of latent vectors in the discrete latent space. In combination with any of the above features in this paragraph, the autoencoder may comprise a vector quantization variable autoencoder (VQVAE). In combination with any of the above features in this paragraph, the text encoder may comprise: an embedding module for positionally embedding the input text and the duration; an attention-based block for injecting information about the text and duration embeddings into a sequence of tokens; and an autoregressive block for predicting the latent sequence. In combination with any of the above features in this paragraph, said attention-based block and said autoregressive block may be transformer-based.

Additional embodiments of the invention provide, among other things, a method for generating a long-term motion representation, the long-term motion comprising a plurality of consecutive actions and a transition between each consecutive pair of the plurality of consecutive actions, the method comprising: receiving a text input comprising a plurality of phrases, each phrase describing an action, wherein the plurality of phrases have a length that is independent of the length of a corresponding motion; receiving one or more durations, the durations comprising a motion length for each action; generating the long-term motion representation conditioned on the text input and the durations, wherein generating comprises: transforming the text input and duration into a sequence of pose indices; dereferencing the sequence of pose indices to identify a sequence of latent vector representations, each latent vector representation comprising a vector in a discrete latent space and representing a fixed length of motion; concatenating the sequence of latent vector representations, the concatenated set of latent vector representations comprising a continuous stream of latent vectors; and decoding the continuous stream of latent vectors using a motion decoder to generate the long-term motion representation; and providing the long-term motion representation conditioned on the text input and the durations for one or more of (a) display on at least one display, and (b) control of at least one autonomous device. In combination with any of the above features in this paragraph, the pose indices may be associated with a structured index. In combination with any of the above features in this paragraph, the structured index may be generated by training an auto-encoder. In combination with any of the above features in this paragraph, the structured index may map text pose indices to a distinct representation of motion having the fixed length of motion. In combination with any of the above features in this paragraph, each of the one or more durations may be determined using an average duration obtained from training data associated with the phrase describing the action. In combination with any of the above features in this paragraph, the auto-encoder may be trained by: training a motion encoder of the autoencoder to compress and map an input motion into a latent representation comprising a sequence of latent vectors in the discrete latent space, each latent vector representing the fixed length of motion; training a quantization module of the autoencoder to quantize the sequence of latent vectors to a sequence of quantized latent vectors in quantized latent space; and training a motion decoder of the autoencoder to reconstruct the quantized sequence of latent vectors as a sequence of single-frame pose representations. In combination with any of the above features in this paragraph, the motion encoder and the motion decoder each may comprise a convolutional layer with a local receptive field for limiting latent vector representations to a fixed local region. In combination with any of the above features in this paragraph, the long-term motion representation decoded by the decoding may include motion coarticulating actions described by the plurality of phrases. In combination with any of the above features in this paragraph, the long-term motion representation decoded by said decoding may comprise a plurality of frames, each frame comprising a three-dimensional representation of an entity. In combination with any of the above features in this paragraph, the three-dimensional representation may comprise a mesh or skeleton of the entity defined by 3D points or parameters.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. All publications, patents, and patent applications referred to herein are hereby incorporated by reference in their entirety, without an admission that any of such publications, patents, or patent applications necessarily constitute prior art.

It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between features (e.g., between modules, circuit elements, semiconductor layers, etc.) may be described using various terms, such as “connected,” “engaged,” “coupled,” “adjacent,” “next to,” “on top of,” “above,” “below,” “disposed”, and similar terms. Unless explicitly described as being “direct,” when a relationship between first and second features is described in the disclosure herein, the relationship can be a direct relationship where no other intervening features are present between the first and second features, or can be an indirect relationship where one or more intervening features are present, either spatially or functionally, between the first and second features, where practicable. As used herein, the phrase “at least one of” A, B, and C or the phrase “at least one of” A, B, or C, should be construed to mean a logical (A OR B OR C), using a non-exclusive logical OR, and should not be construed to mean “at least one of A, at least one of B, and at least one of C.”

In the figures, the direction of an arrow, as indicated by an arrowhead, generally demonstrates an example flow of information, such as data or instructions, that is of interest to the illustration. A unidirectional arrow between features does not imply that no other information may be transmitted between features in the opposite direction.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A method for training a model for generating a representation of long-term motion from a text input, where the long-term motion comprises a plurality of consecutive actions and a transition between each consecutive pair of the plurality of consecutive actions, the method comprising:
training an autoencoder, said training comprising:
training a motion encoder of the autoencoder to compress and map an input motion into a latent representation comprising a sequence of latent vectors in a discrete latent space, each latent vector representing a fixed length of motion;
training a quantization module of the autoencoder to quantize the sequence of latent vectors to a sequence of quantized latent vectors in quantized latent space; and
training a motion decoder of the autoencoder to reconstruct the quantized sequence of latent vectors as a sequence of single-frame pose representations; and
training a text encoder connected to the trained autoencoder to predict a latent sequence conditioned on a text input and a duration using the mapped latent representation generated by the trained motion encoder as a target;
wherein said training the autoencoder and said training the text encoder both use a dataset of single actions and associated text;
wherein, in the trained model, the trained text encoder receives a text input comprising a plurality of phrases, where each phrase describes an action, and processes the received text input and a received duration to predict a latent sequence, the trained quantization module quantizes the latent sequence from the predicted latent sequence, and the trained motion decoder decodes the quantized latent sequence to output parameters for generating the representation of long-term motion; and
wherein the representation of long-term motion is provided for one or more of (a) display on at least one display, and (b) control of at least one autonomous device.

2. The method of claim 1, wherein the representation of long-term motion comprises a plurality of frames, each frame comprising a three-dimensional representation of an entity.

3. The method of claim 2, wherein said quantizing the sequence of quantized latent vectors in quantized latent space is based on closest stored latent vectors, the stored latent vectors being stored as entries in one or more codebooks.

4. The method of claim 1, wherein the text encoder comprises an embedding module for positionally embedding the input text and the duration, an attention-based block for injecting information about the text and duration embeddings into a sequence of tokens, and an autoregressive block for predicting the latent sequence.

5. The method of claim 4,
wherein the attention-based block comprises a transformer-based encoder;
and
wherein the autoregressive block comprises a transformer-based model configured to autoregressively sample next indices.

6. The method of claim 5, wherein the embedding module is configured to:
encode the input text;
embed the duration; and
concatenate the encoded input text with the embedded duration along a time dimension, and with positional embedding vectors representing a temporal dimension in latent space.

7. The method of claim 6, wherein said training the text encoder comprises:
training the transformer-based encoder to generate a sequence of text-length embeddings from the positionally embedded input text and duration; and
training the autoregressive block for autoregressive next index prediction from the sequence of text-length embeddings to generate the latent sequence;
wherein said training the text encoder uses a causal mask.

8. A method for generating a long-term motion representation, the long-term motion comprising a plurality of consecutive actions and a transition between each consecutive pair of the plurality of consecutive actions, the method comprising:
receiving a text input comprising a plurality of phrases, each phrase describing an action, wherein the plurality of phrases have a length that is independent of the length of a corresponding motion;
receiving one or more durations, the durations comprising a motion length for each action;
generating the long-term motion representation conditioned on the text input and the durations, wherein said generating comprises:
predicting, using the text input and the durations, a latent representation comprising a continuous stream of latent vectors, each latent vector representing a fixed length of motion, each latent vector comprising a vector in a discrete latent space; and
decoding the latent representation comprising the predicted continuous stream of latent vectors using a motion decoder to continuously reconstruct the long-term motion representation, the motion decoder being a decoder of an autoencoder trained to compress motion to sequences of latent vectors, the autoencoder comprising the motion decoder and a quantization module, the autoencoder during training further comprising a motion encoder; and
providing the long-term motion representation conditioned on the text input and the durations for one or more of (a) display on at least one display, and (b) control of at least one autonomous device.

9. The method of claim 8, wherein said predicting comprises encoding the text input and the durations using a text encoder to predict a continuous stream of indices in discrete latent space, the text encoder being trained to map the text input and the duration to the continuous stream of indices; and
wherein the text encoder and the autoencoder are both trained with a dataset of single actions and associated text.

10. The method of claim 9, wherein the indices comprise codebook indices associated with entries in one or more codebooks of stored latent vectors in a discrete latent space.

11. The method of claim 9, wherein said encoding the text input and the durations comprises:
embedding the text input and the durations;
injecting, using an attention-based block, said embedded text input and the duration into a sequence of positional embeddings; and
predicting, using an autoregressive attention-based block, the continuous stream of indices;
wherein the number of positional embeddings in the sequence is based on a motion length, wherein the motion length is downscaled.

12. The method of claim 9, further comprising:
dereferencing each of the predicted indices in the stream by quantizing the predicted indices to closest stored latent vectors in the discrete latent space to determine the latent vectors; and
concatenating the determined latent vectors to provide the continuous stream of latent vectors.

13. The method of claim 8, wherein the representation of long-term motion comprises a plurality of frames, each frame comprising a three-dimensional representation of an entity;
wherein the entity is a human or a robot.

14. A processor-based system for generating a long-term motion representation, the long-term motion comprising a plurality of consecutive actions and a transition between each consecutive pair of the consecutive actions, the system comprising:
a text encoder configured to:
receive a text input comprising a plurality of phrases, each phrase describing an action, wherein the plurality of phrases have a length that is independent of the length of a corresponding motion;
receive one or more durations, the durations comprising a motion length for each action; and
predict a set of pose indices referencing a latent representation comprising a continuous stream of latent vectors, each latent vector representing a fixed length of motion, each latent vector comprising a vector in a discrete latent space;
a motion decoding autoencoder configured to:
dereference the set of pose indices and concatenate the continuous stream of latent vectors to provide a sequence of quantized latent vectors in quantized latent space; and
decode the sequence of quantized latent vectors to generate the long-term motion representation; and
a device using the long-term motion representation for one or more of (a) visual display on at least one display, and (b) control of at least one autonomous device.

15. The system of claim 14, wherein the autoencoder and the text encoder are trained using a dataset of single actions and associated text.

16. The system of claim 15, wherein the autoencoder, when it is trained, further comprises:
a motion encoder configured to compress and map an input motion into a latent representation comprising a sequence of latent vectors in the discrete latent space.

17. The system of claim 16, wherein the text encoder comprises:
an embedding module for positionally embedding the input text and the duration;
an attention-based block for injecting information about the text and duration embeddings into a sequence of tokens; and
an autoregressive block for predicting the latent sequence.

18. A method for generating a long-term motion representation, the long-term motion comprising a plurality of consecutive actions and a transition between each consecutive pair of the plurality of consecutive actions, the method comprising:
receiving a text input comprising a plurality of phrases, each phrase describing an action, wherein the plurality of phrases have a length that is independent of the length of a corresponding motion;
receiving one or more durations, the durations comprising a motion length for each action;
generating the long-term motion representation conditioned on the text input and the durations, wherein said generating comprises:
transforming the text input and duration into a sequence of pose indices;
dereferencing the sequence of pose indices to identify a sequence of latent vector representations, each latent vector representation comprising a vector in a discrete latent space and representing a fixed length of motion;
concatenating the sequence of latent vector representations, the concatenated set of latent vector representations comprising a continuous stream of latent vectors; and
decoding the continuous stream of latent vectors using a motion decoder to generate the long-term motion representation; and
providing the long-term motion representation conditioned on the text input and the durations for one or more of (a) display on at least one display, and (b) control of at least one autonomous device.

19. The method of claim 18, wherein the pose indices are associated with a structured index generated by training an auto-encoder.

20. The method of claim 19, wherein the structured index maps text pose indices to a distinct representation of motion having the fixed length of motion.

21. The method of claim 20, wherein each of the one or more durations is determined using an average duration obtained from training data associated with the phrase describing the action.

22. The method of claim 19, wherein the auto-encoder is trained by:
training a motion encoder of the autoencoder to compress and map an input motion into a latent representation comprising a sequence of latent vectors in the discrete latent space, each latent vector representing the fixed length of motion;
training a quantization module of the autoencoder to quantize the sequence of latent vectors to a sequence of quantized latent vectors in quantized latent space; and
training a motion decoder of the autoencoder to reconstruct the quantized sequence of latent vectors as a sequence of single-frame pose representations.

23. The method of claim 22, wherein the motion encoder and the motion decoder each comprise a convolutional layer with a local receptive field for limiting latent vector representations to a fixed local region.

24. The method of claim 18, wherein the long-term motion representation decoded by said decoding includes motion coarticulating actions described by the plurality of phrases.

25. The method of claim 18, wherein the long-term motion representation decoded by said decoding comprises a plurality of frames, each frame comprising a three-dimensional representation of an entity.

26. The method of claim 25, wherein the three-dimensional representation comprises a mesh or skeleton of the entity defined by 3D points or parameters.
